(19) United States
(12) Patent Application Publication
(10) Pub. No.: US 2003/0220704 A1
(43) Pub. Date: Nov. 27, 2003

(54) Remote service offering system

(75) Inventors: Masahiko Nanbu, Tokyo (JP); Ikuo Ikeda, Tokyo (JP); Tomohiro Mizukami, Tokyo (JP); Michio Tonosaki, Tokyo (JP); Mitsuo Katagiri, Tokyo (JP); Tadao Mizuno, Tokyo (JP); Takaaki Maekawa, Tokyo (JP)

Correspondence Address: SUGHRUE MION, PLLC, 2100 PENNSYLVANIA AVENUE, N.W., WASHINGTON, DC, 20037, US

(73) Assignee: MITSUBISHI DENKI KABUSHIKI KAISHA

(21) Appl. No.: 10/437,966

(22) Filed: May 15, 2003

(30) Foreign Application Priority Data
May 21, 2002 (JP) 2002-146647
Nov. 25, 2002 (JP) 2002-341021

(51) Int. Cl. G05B 19/18; G05B 15/00

(52) U.S. Cl. 700/65; 700/66

(57) ABSTRACT

A remote service offering system is provided, which includes a plant having a plant server and a plant controller, an end user terminal, and a center having a center database and a center server, the plant, the end user terminal and the center being connected to one another through a wide-area network. When the center server receives a request for display of accumulated information from the end user terminal, it obtains accumulated information held by the plant server and provides the accumulated information to the end user terminal. When the center server receives a request for display of real-time information from the end user terminal, it obtains real-time information collected by the plant controller and provides the real-time information to the end user terminal.

### BACKGROUND OF THE INVENTION

1. Field of the Invention

The present invention relates to a remote service offering system for offering a service based on a process in which information on the conditions of maintenance, monitoring, etc., of an object at a site is obtained from a remote place via a network and is processed.

2. Description of the Related Art

Monitoring of an object from a remote place using the Web is known. For example, Japanese Patent Laid-Open No. 11-164035 and Japanese Patent Laid-Open No. 11-17678 disclose systems for such monitoring. Each of the arts disclosed in these publications enables a remote monitoring and operating system, which requires a special-purpose high-priced device if constructed on the basis of a conventional method, to be constructed at a low cost using general-purpose techniques relating to WWW servers and the internet. This system also has the advantage of enabling monitoring or operations from a general-purpose terminal such as a personal computer.

The object of monitoring in each of the systems disclosed in the above-mentioned publications is limited to particular kinds of apparatus or a restricted number of objects, and a structure has not been realized in which one server can be shared among a plurality of different systems.

On the other hand, Japanese Patent Laid-Open No. 10124418 discloses a method of performing remote monitoring of a plurality of apparatuses by using a plurality of WWW servers. This method is provided as a method of monitoring and controlling a plurality of remote apparatuses by dynamically downloading a program called an applet from a second WWW server.

This method enables monitoring and control of a plurality of remote apparatuses but does not enable each of executions of monitoring and control to be individually grasped, since the same applet is used for monitoring and control of the plurality of remote apparatuses. This means that a fine setting of each individual operation cannot be made.

The above-described three conventional arts lack management of a record containing information for identification of a terminal and a kind of operation with respect to each of executions of monitoring and control. Therefore they do not enable, for example, a pay service for monitoring and control requiring charging for each of individual operations.

In conventional remote service offering systems, the object to be monitored by the system is limited to particular kinds of apparatus or a restricted number of objects, and a structure has not been realized in which one server can be shared among a plurality of different systems. Therefore, there has been a problem in that in a case where remote monitoring of a plurality of systems or the like is performed, there is a need to incorporate a new system and the cost for constructing the entire system is high.

There has also been a problem in that even though monitoring and control of a plurality of apparatuses can be performed, each of executions of monitoring and control cannot be individually grasped, and therefore, a fine setting of each of individual operations cannot be made.

Further, there has been a problem in that management of a record containing information for identification of a terminal and a kind of operation with respect to each of executions of monitoring and control cannot be performed, and therefore, it is not possible to enable, for example, a pay service for monitoring and control requiring charging for each of individual operations.

### SUMMARY OF THE INVENTION

In view of the above-described problems, an object of the present invention is to provide a remote service offering system which is constructed at a low cost and which enables a fine setting of each of individual operations and management of a record of operations.

A remote service offering system according to the present invention includes a plant having a plant server and a plant controller, an end user terminal, and a center having a center database and a center server, the plant, the end user terminal and the center being connected to one another through a wide-area network, in which when the center server receives a request for display of accumulated information from the end user terminal, the center server obtains accumulated information held by the plant server and provides the obtained information to the end user terminal, and in which when the center server receives a request for display of real-time information from the end user terminal, the center server obtains real-time information collected by the plant controller and provides the obtained information to the end user terminal.

Thus, the remote service offering system has an advantage of enabling exchange of information via the center server and handling of all pieces of information via the center server with respect to all end user requests.

A remote service offering system according to the present invention includes an end user terminal and a center having a center database and a center server, the end user terminal and the center being connected to each other through a wide-area network, in which when the center server receives a request for acquisition of predetermined information from the end user terminal, the center server checks user information corresponding to the end user terminal in the center database, and provides the predetermined information to the end user terminal based on the user information if the user information exists in the center database and rejects the request for acquisition of the predetermined information if the user information does not exist in the center database.

Thus, the remote service offering system has an advantage of providing end users with information according to user information.

A remote service offering system according to the present invention includes a plant having a plant server and a plant controller, an end user terminal, and a center having a center database and a center server, the plant, the end user terminal and the center being connected to one another through a wide-area network, in which when the center server receives a request for display of accumulated information from the end user terminal, the center server obtains accumulated information held by the plant server, stores the obtained information in the center database, and provides the obtained information to the end user terminal, and in which when the plant controller receives a request for display of real-time information from the end user terminal, the center server provides the corresponding collected real-time information to the end user terminal, and when receiving a notice of termination of display of real-time information from the end user terminal via the center server, the plant controller terminates the provision of real-time information to the end user terminal.

Thus, the remote service offering system has an advantage of enabling direct processing between a plant and an end user of real-time information which needs to be immediately processed.

A remote service offering system according to the present invention includes a plant having a plant server and a plant controller, an end user terminal, and a center having a center database and a center server, the plant, the end user terminal and the center being connected to one another through a wide-area network, in which when the center server receives a request for display of accumulated information from the end user terminal, the center server obtains accumulated information held by the plant server, stores the obtained information in the center database, and provides the obtained information to the end user terminal, and in which when the plant controller receives a request for display of real-time information from the end user terminal, the center server provides the corresponding collected real-time information to the end user terminal, and when directly receiving a notice of termination of display of real-time information from the end user terminal, the plant controller terminates the provision of real-time information to the end user terminal.

Thus, the remote service offering system has an advantage of enabling direct processing between a plant and an end user of real-time information which needs to be immediately processed.

### BRIEF DESCRIPTION OF THE DRAWINGS

In the accompanying drawings:

FIG. 1 is a diagram showing the configuration of a remote service offering system according to Embodiment 1 of the present invention;

FIG. 2 is a flowchart of the operation of the remote service offering system according to Embodiment 1 of the present invention;

FIG. 3 is a flowchart of the operation of the remote service offering system according to Embodiment 1 of the present invention;

FIG. 4 is a flowchart of the operation of the remote service offering system according to Embodiment 1 of the present invention;

FIG. 5 is a flowchart of the operation of a remote service offering system according to Embodiment 2 of the present invention;

FIG. 6 is a flowchart of the operation of the remote service offering system according to Embodiment 2 of the present invention;

FIG. 7 is a flowchart of the operation of the remote service offering system according to Embodiment 2 of the present invention;

FIG. 8 is a flowchart of the operation of the remote service offering system according to Embodiment 2 of the present invention;

FIG. 9 is a diagram showing the configuration of a remote service offering system according to Embodiment 3 of the present invention;

FIG. 10 is a flowchart of the operation of the remote service offering system according to Embodiment 3 of the present invention;

FIG. 11 is a flowchart of the operation of a remote service offering system according to Embodiment 4 of the present invention;

FIG. 12 is a flowchart of the operation of the remote service offering system according to Embodiment 4 of the present invention;

FIG. 13 is a flowchart of the operation of the remote service offering system according to Embodiment 4 of the present invention;

FIG. 14 is a flowchart of the operation of the remote service offering system according to Embodiment 4 of the present invention;

FIG. 15 is a diagram showing the configuration of a remote service offering system according to Embodiment 5 of the present invention;

FIG. 16 is a flowchart of the operation of the remote service offering system according to Embodiment 5 of the present invention;

FIG. 17 is a diagram showing the configuration of a remote service offering system according to Embodiment 6 of the present invention;

FIG. 18 is a flowchart of the operation of the remote service offering system according to Embodiment 6 of the present invention;

FIG. 19 is a flowchart of the operation of the remote service offering system according to Embodiment 6 of the present invention;

FIG. 20 is a diagram showing the configuration of a remote service offering system according to Embodiment 7 of the present invention;

FIG. 21 is a flowchart of the operation of the remote service offering system according to Embodiment 7 of the present invention;

FIG. 22 is a flowchart of the operation of the remote service offering system according to Embodiment 7 of the present invention;

FIG. 23 is a flowchart of the operation of a remote service offering system according to Embodiment 8 of the present invention;

FIG. 24 is a flowchart of the operation of the remote service offering system according to Embodiment 8 of the present invention;

FIG. 25 is a flowchart of the operation of the remote service offering system according to Embodiment 8 of the present invention;

FIG. 26 is a flowchart of the operation of the remote service offering system according to Embodiment 8 of the present invention;

FIG. 27 is a flowchart of the operation of a remote service offering system according to Embodiment 9 of the present invention;

FIG. 28 is a flowchart of the operation of the remote service offering system according to Embodiment 9 of the present invention;

FIG. 29 is a flowchart of the operation of the remote service offering system according to Embodiment 9 of the present invention;

FIG. 30 is a flowchart of the operation of the remote service offering system according to Embodiment 9 of the present invention;

FIG. 31 is a diagram showing a charge (yen) with respect to the distance (the amount of information) in a remote service offering system according to Embodiment 10 of the present invention;

FIG. 32 is a diagram showing a charge (yen) with respect to the distance (the amount of information) in the remote service offering system according to Embodiment 10 of the present invention;

FIG. 33 is a diagram showing a charge (yen) with respect to the distance (the amount of information) in the remote service offering system according to Embodiment 10 of the present invention;

FIG. 34 is a diagram showing a charge (yen) with respect to the distance (the amount of information) in the remote service offering system according to Embodiment 10 of the present invention;

FIG. 35 is a diagram showing a charge (yen) with respect to the distance (the amount of information) in the remote service offering system according to Embodiment 10 of the present invention;

FIG. 36 is a diagram showing a charge (yen) with respect to the distance (the amount of information) in the remote service offering system according to Embodiment 10 of the present invention;

FIG. 37 is a diagram showing a charge (yen) with respect to the connection time in the remote service offering system according to Embodiment 10 of the present invention;

FIG. 38 is a diagram showing a charge (yen) with respect to the connection time in the remote service offering system according to Embodiment 10 of the present invention;

FIG. 39 is a diagram showing a charge (yen) with respect to the connection time in the remote service offering system according to Embodiment 10 of the present invention;

FIG. 40 is a diagram showing a charge (yen) with respect to the connection time in the remote service offering system according to Embodiment 10 of the present invention;

FIG. 41 is a diagram showing a charge (yen) with respect to the connection time in the remote service offering system according to Embodiment 10 of the present invention;

FIG. 42 is a diagram showing a charge (yen) with respect to the connection time in the remote service offering system according to Embodiment 10 of the present invention;

FIG. 43 is a diagram showing a charge (yen) with respect to kinds of information in the remote service offering system according to Embodiment 10 of the present invention;

FIG. 44 is a diagram showing an example of kinds of information in the remote service offering system according to Embodiment 10 of the present invention;

FIG. 45 is a diagram showing a charge (yen) with respect to kinds of users in the remote service offering system according to Embodiment 10 of the present invention;

FIG. 46 is a diagram showing the configuration of a remote service offering system according to Embodiment 11 of the present invention;

FIG. 47 is a flowchart of the operation of the remote service offering system according to Embodiment 11 of the present invention;

FIG. 48 is a flowchart of the operation of the remote service offering system according to Embodiment 11 of the present invention;

FIG. 49 is a flowchart of the operation of the remote service offering system according to Embodiment 11 of the present invention;

FIG. 50 is a flowchart of the operation of the remote service offering system according to Embodiment 11 of the present invention;

FIG. 51 is a flowchart of the operation of a remote service offering system according to Embodiment 12 of the present invention;

FIG. 52 is a flowchart of the operation of the remote service offering system according to Embodiment 12 of the present invention;

FIG. 53 is a flowchart of the operation of the remote service offering system according to Embodiment 12 of the present invention;

FIG. 54 is a diagram showing the configuration of a remote service offering system according to Embodiment 13 of the present invention;

FIG. 55 is a flowchart of the operation of the remote service offering system according to Embodiment 13 of the present invention;

FIG. 56 is a flowchart of the operation of the remote service offering system according to Embodiment 13 of the present invention;

FIG. 57 is a flowchart of the operation of the remote service offering system according to Embodiment 13 of the present invention;

FIG. 58 is a flowchart of the operation of the remote service offering system according to Embodiment 13 of the present invention;

FIG. 59 is a flowchart of the operation of a remote service offering system according to Embodiment 14 of the present invention;

FIG. 60 is a flowchart of the operation of the remote service offering system according to Embodiment 14 of the present invention;

FIG. 61 is a flowchart of the operation of a remote service offering system according to Embodiment 15 of the present invention;

FIG. 62 is a flowchart of the operation of a remote service offering system according to Embodiment 16 of the present invention;

FIG. 63 is a flowchart of the operation of the remote service offering system according to Embodiment 16 of the present invention;

FIG. 64 is a flowchart of the operation of the remote service offering system according to Embodiment 16 of the present invention; and

FIG. 65 is a flowchart of the operation of the remote service offering system according to Embodiment 16 of the present invention.

### DESCRIPTION OF THE PREFERRED EMBODIMENTS

Embodiment 1

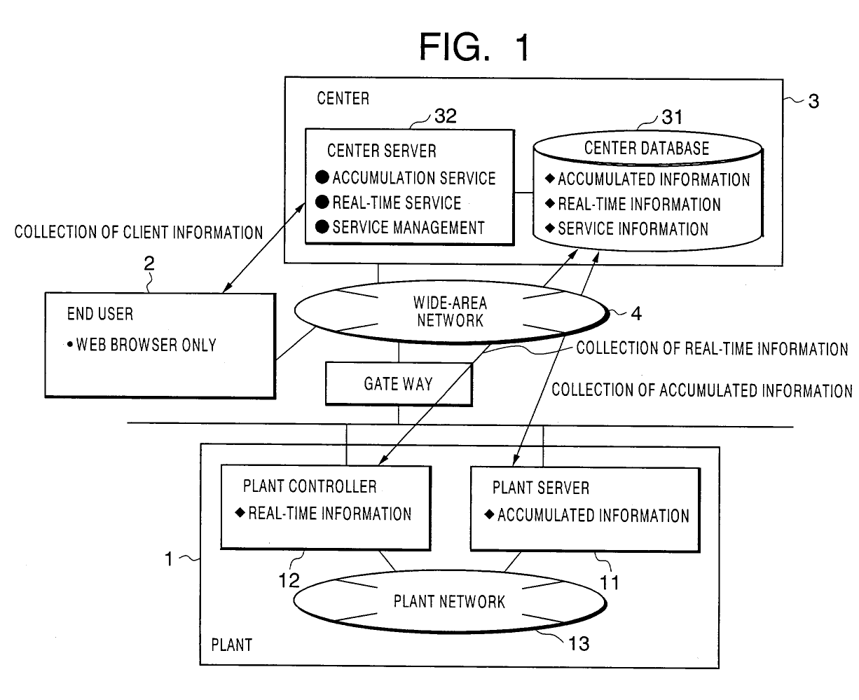

A remote service offering system according to Embodiment 1 of the present invention will be described with reference to the drawings. FIG. 1 is a diagram showing a configuration of the remote service offering system according to Embodiment 1 of the present invention. The same reference numerals in the drawings designate components identical or equivalent to each other.

The system shown in FIG. 1 includes a plant 1 in operation, an end user 2 who owns the plant and who has a personal computer (PC) having functions corresponding to the functions of a Web browser or the like, a center 3 having a function of intervening in exchange of information between the plant 1 and the end user 2, and a wide-area network 4 in which the plant 1, the end user 2 and the center 3 are connected.

The system shown in FIG. 1 also includes a plant server 11 having a function of storing accumulated information, a plant controller 12 having a function of holding real-time information, and a plant network 13 having a function of connecting the plant server 11 and the plant controller 12 in the plant 1.

The system shown in FIG. 1 also includes a center database 31 which holds information accumulated in the plant server 11 of the plant 1, real-time information obtained by the plant controller 12, and service information for the end user 2, and a center server 32 which manages various kinds of service.

The plant server 11 and the plant controller 12 provided in the plant 1 and the center database 31 and the center server 32 provided in the center 3 are respectively connected to the wide-area network 4 along with the end user 2. These system components enable a remote service to be offered. All pieces of information are processed via the center.

The operation of the remote service offering system according to Embodiment 1 of the present invention will now be described with reference to the drawings.

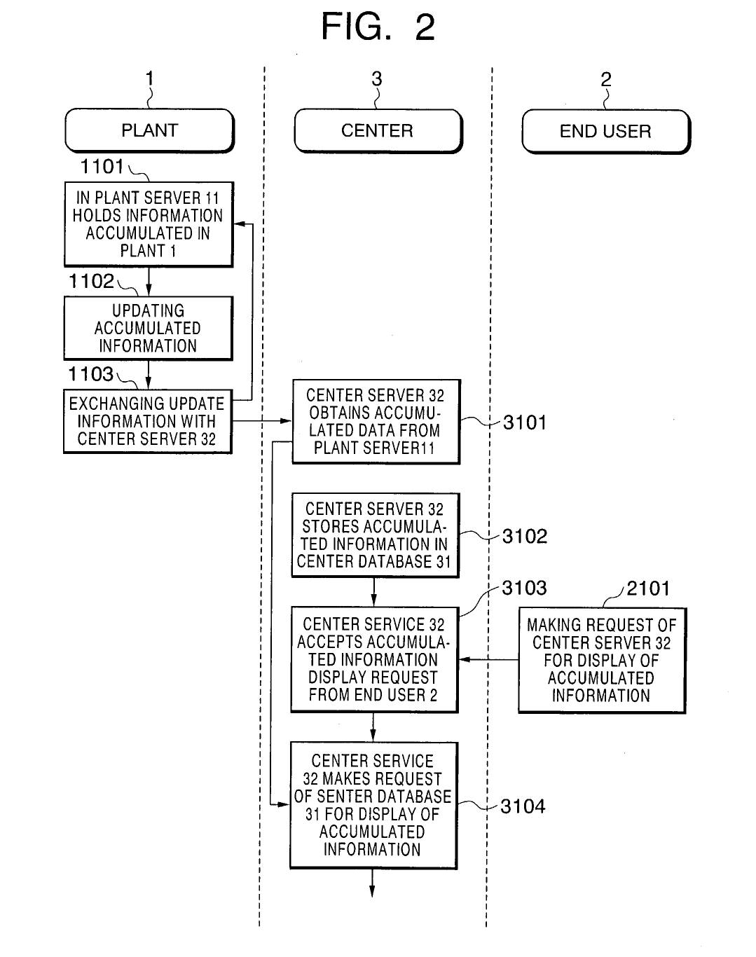

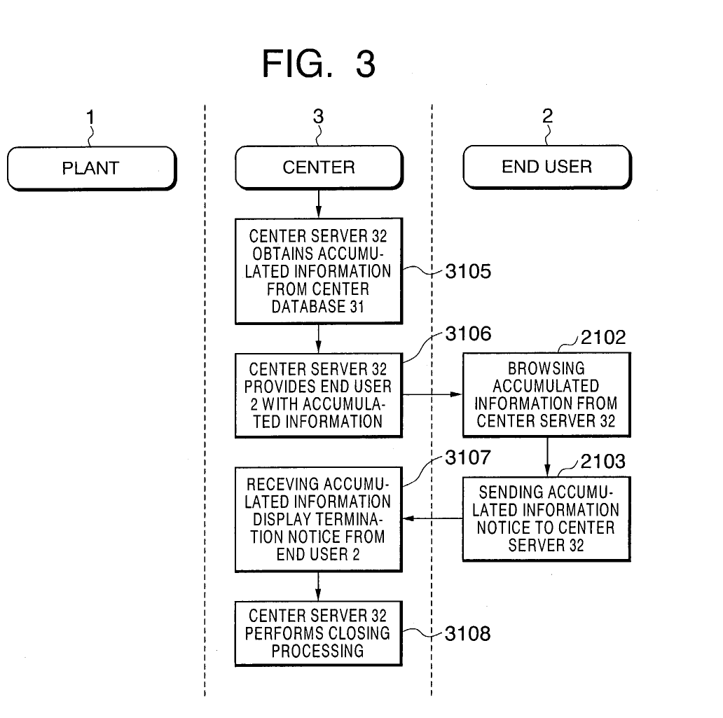

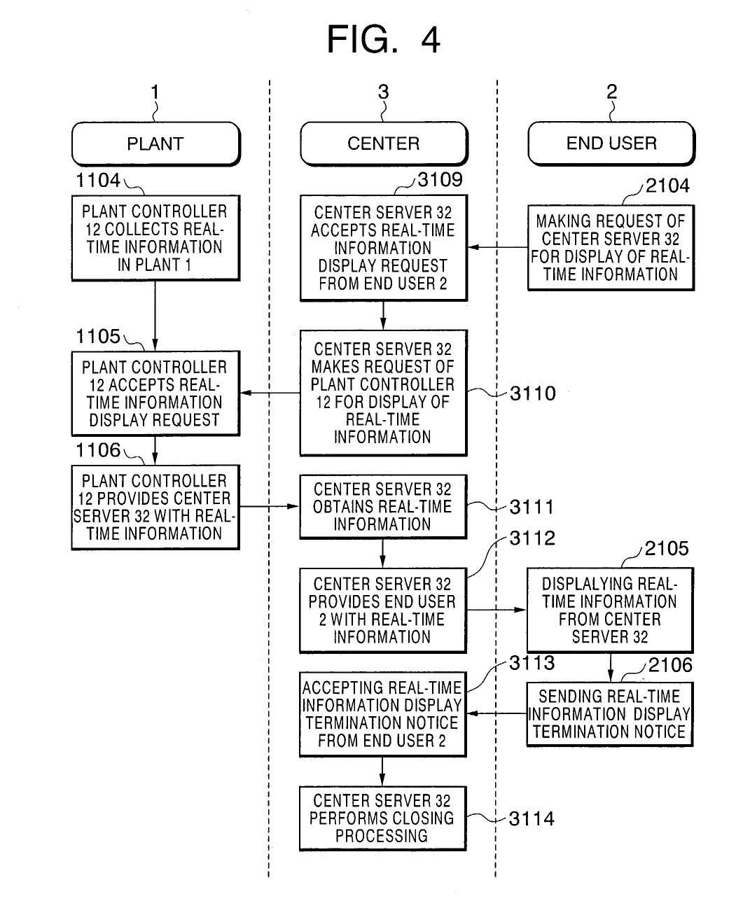

FIGS. 2, 3, and 4 are flowcharts showing the operation of the remote service offering system according to Embodiment 1 of the present invention.

In steps 1101 to 1103 shown in FIG. 2, the plant server 11 holds information accumulated in the plant 1. The plant server 11 also updates the accumulated information. Further, the plant server 11 exchanges updated information with the center server 32.

In steps 3101 and 3102, the center server 32 obtains accumulated information from the plant server 11. The center server 32 then stores the accumulated information in the center database 31.

In step 2101, the end user 2 makes a request of the center server 32 for display of accumulated information.

In steps 3103 to 3106, the center server 32 accepts the accumulated information display request from the end user 2 and makes a request of the center database 31 for display of accumulated information. The center server 32 obtains accumulated information from the center database 31 and provides the accumulate information to the end user 2.

In steps 2102 and 2103, the end user 2 browses the accumulated information from the center server 32 and sends a notice of termination of display of the accumulated information to the center server 32.

In steps 3107 and 3108, the center server 32 accepts the accumulated information display termination notice from the end user 2 and performs closing processing.

In step 1104, the plant controller 12 collects real-time information in the plant 1.

In step 2104, the end user 2 makes a request of the center server 32 for display of real-time information.

In steps 3109 and 3110, the center server 32 accepts the real-time information display request from the end user 2 and makes a request of the plant controller 12 for display of real-time information.

In steps 1105 and 1106, the plant controller 12 accepts the real-time information display request from the center server 32 and provides real-time information to the center server 32.

In steps 3111 and 3112, the center server 32 obtains the real-time information from the plant controller 12 and provides the real-time information to the end user 2.

In steps 2105 and 2106, the end user 2 displays the real-time information from the center server 32 and sends a notice of termination of display of the real-time information to the center server 32.

In steps 3113 and 3114, the center server 32 accepts the real-time information display termination notice from the end user 2 and performs closing processing.

Through the above-described procedure, exchange of information via the center server 32 can be controlled in the center 3 at all requests from the end user 2. Also, every piece of information can be handled via the center server 32.

Embodiment 2

A remote service offering system according to Embodiment 2 of the present invention will be described with reference to the drawings. A configuration of the remote service offering system according to Embodiment 2 of the present invention is the same as that in Embodiment 1.

In Embodiment 1 described above, all pieces of information are handled via the center server 32. In this Embodiment 2, all pieces of information are handled via the center server 32 and control of the plant is also performed through the center server 32.

The operation of the remote service offering system according to Embodiment 2 of the present invention will now be described with reference to the drawings.

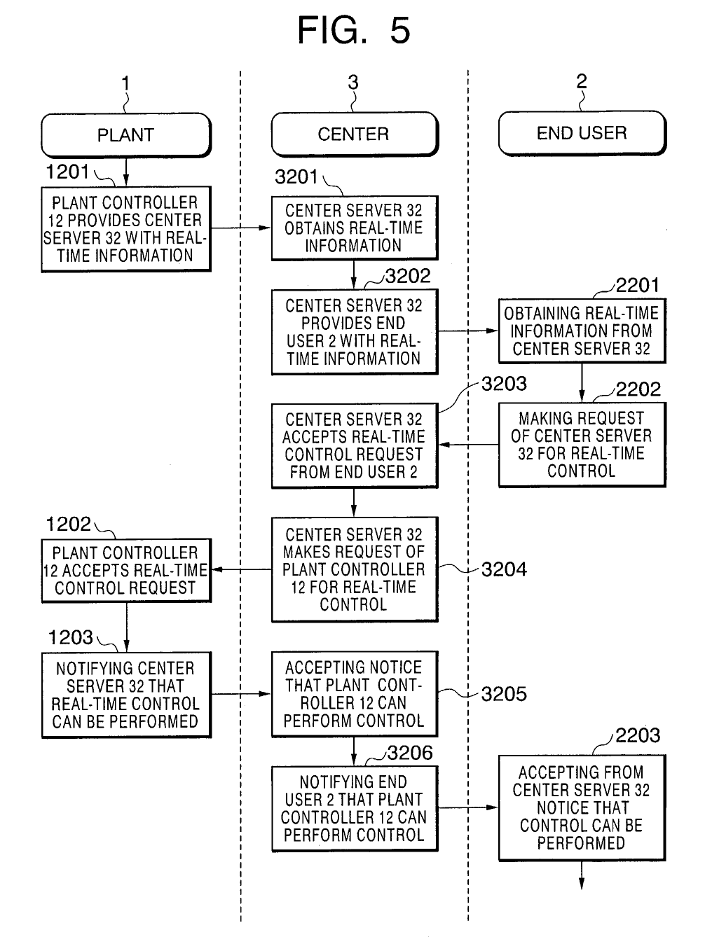

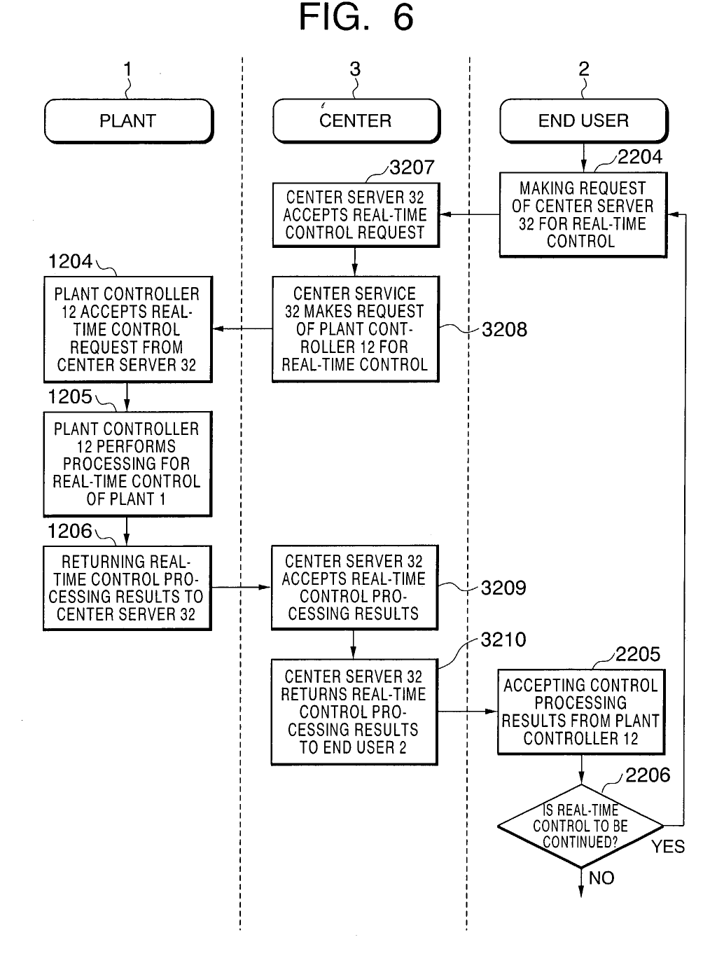

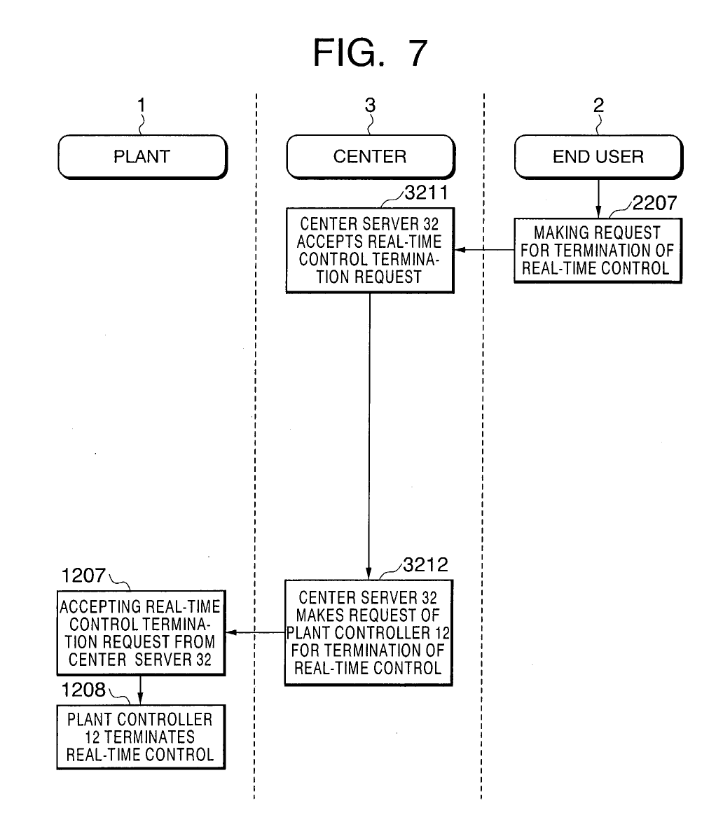

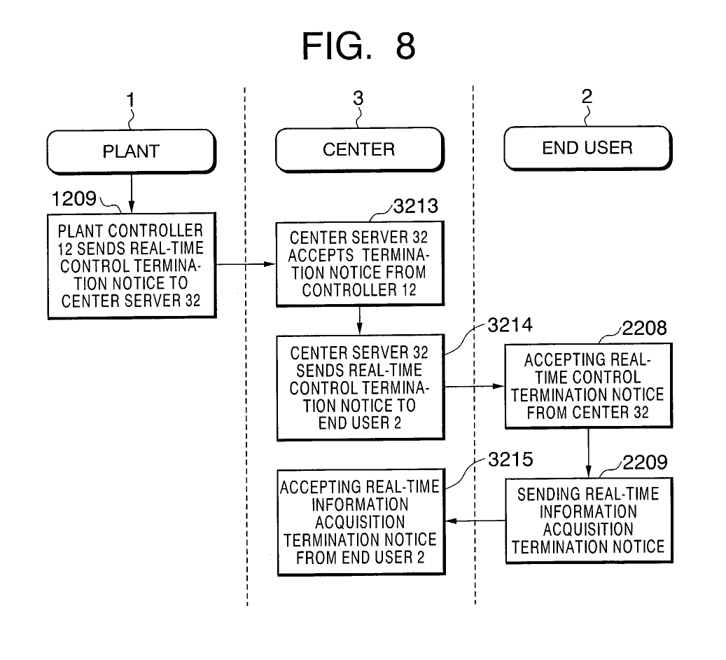

FIGS. 5 to 8 are flowcharts showing the operation of the remote service offering system according to Embodiment 2 of the present invention.

The operation before step 2201 is the same as that in Embodiment 1.

In step 2202 shown in FIG. 5, the end user 2 makes a request of the center server 32 for a start of real-time control.

In steps 3203 and 3204, the center server 32 accepts the real-time control start request from the end user 2 and makes a request of the plant controller 12 for real-time control.

In steps 1202 and 1203, the plant controller 12 accepts the real-time control request from the center server 32 and notifies the center server 32 that real-time control can be performed.

In steps 3205 and 3206, the center server 32 accepts from the plant controller 12 the notice that the real-time control can be performed, and notifies the end user 2 that real-time control can be performed.

In steps 2203 and 2204, the end user 2 accepts from the center server 32 the notice that the real-time control can be performed, and makes a request of the center server 32 for real-time control.

In steps 3207 and 3208, the center server 32 accepts the real-time control request from the end user 2 and makes a request of the plant controller 12 for real-time control.

In steps 1204 to 1206, the plant controller 12 accepts the real-time control request from the center server 32 and performs real-time control processing on the plant 1. The plant controller 12 thereafter notifies the center server 32 of the results of real-time control processing.

In steps 3209 and 3210, the center server 32 accepts the results of real-time control processing from the plant controller 12 and notifies the end user 2 of the results of real-time control processing.

In steps 2205 to 2207, the end user 2 accepts the results of real-time control processing from the plant controller 2. If real-time control is to be continued, the end user 2 makes the process return to step 2204. If real-time control is to be stopped, the end user 2 makes a request of the center server 32 for termination of real-time control.

In steps 3211 and 3212, the center server 32 accepts the real-time control termination request from the end user 2 and makes a request of the plant controller 12 for termination of real-time control.

Next, in step 1207 to 1209, the plant controller 12 accepts the real-time control termination request from the center server 32, and terminates the real-time control. The plant controller 12 also notifies the center server 32 of the termination of real-time control.

In steps 3213 and 3214, the center server 32 accepts the real-time control termination notice from the plant controller 12 and notifies the end user 2 of the termination of real-time control.

In steps 2208 and 2209, the end user 2 accepts the real-time control termination notice from the center server 32. After this operation, the process returns to the above-described operation of Embodiment 1.

Through the above-described procedure, all kinds of control selected by the end user 2 can be controlled via the center server 32 in the center 3. Also, all kinds of control can be handled via the center server 32.

Embodiment 3

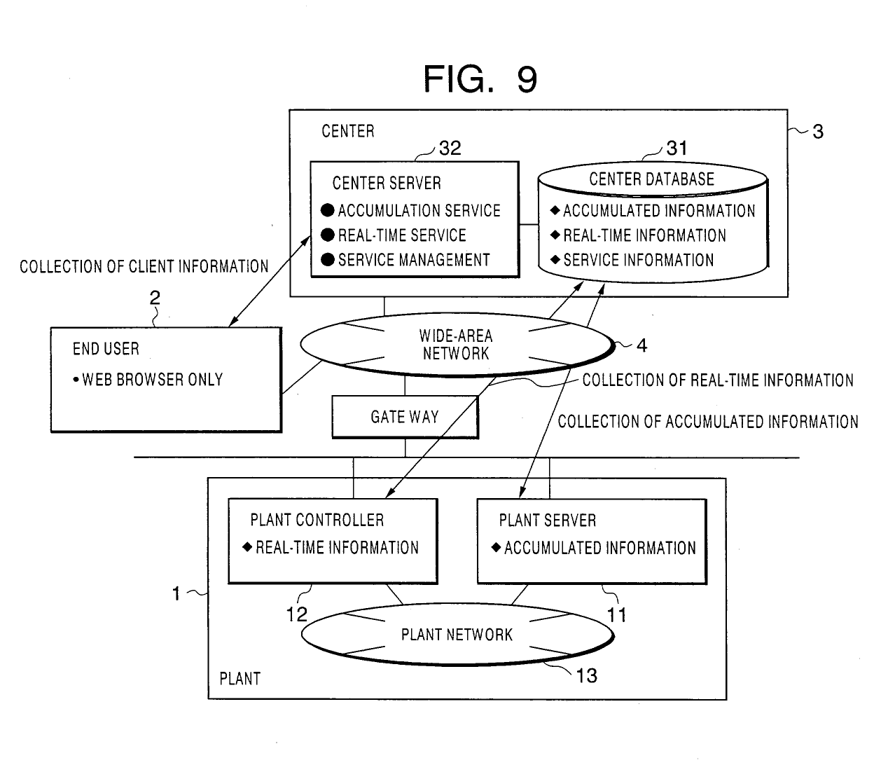

A remote service offering system according to Embodiment 3 of the present invention will be described with reference to the drawings. FIG. 9 is a diagram showing a configuration of the remote service offering system according to Embodiment 3 of the present invention.

The system shown in FIG. 9 includes a plant 1 in operation, an end user 2 who owns the plant and who has a personal computer (PC) having functions corresponding to the functions of a Web browser or the like, a center 3 having a function of intervening in exchange of information between the plant 1 and the end user 2, and a wide-area network 4 such as Internet in which the plant 1, the end user 2 and the center 3 are connected.

The system shown in FIG. 9 also includes a plant server 11 having a function of storing accumulated information, a plant controller 12 having a function of holding real-time information, and a plant network 13 having a function of connecting the plant server 11 and the plant controller 12 in the plant 1.

The system shown in FIG. 9 also includes a center database 31 which holds information accumulated in the plant server 11 of the plant 1, real-time information obtained by the plant controller 12, and service information for the end user 2, and a center server 32 which manages various kinds of service.

The plant server 11 and the plant controller 12 provided in the plant 1 and the center database 31 and the center server 32 provided in the center 3 are respectively connected to the wide-area network 4 along with the end user 2. These system components enable a remote service to be offered. All pieces of information are processed via the center.

The operation of the remote service offering system according to Embodiment 3 of the present invention will now be described with reference to the drawings. In particular, the closing processing will be described as the processing performed via the center.

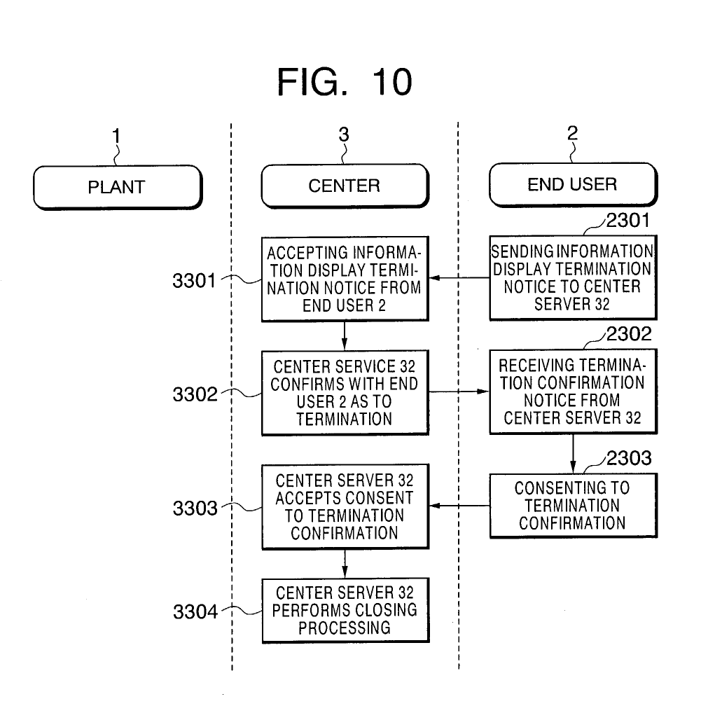

FIG. 10 is a flowchart showing the operation of the remote service offering system according to Embodiment 3 of the present invention.

In step 2301, the end user 2 sends a notice of termination of display of accumulated information to the center server 32.

In steps 3301 and 3302, the center server 32 receives a notice of termination of display of the accumulated information from the end user 2, and make a confirmation of the termination to the end user 2.

In steps 2302 and 2303, the end user 2 receives a notice for confirmation of termination from the center server 32 and consents to the termination confirmation.

In steps 3303 and 3304, the center server 32 accepts the consent of the end user 2 to the termination confirmation and performs closing processing.

Through the above-described procedure, closing processing with respect to exchange of all pieces of information can be performed reliably while making a confirmation to the end user 2.

Embodiment 4

A remote service offering system according to Embodiment 4 of the present invention will be described with reference to the drawings. Note that, a configuration of the remote service offering system according to Embodiment 4 of the present invention is the same as that of Embodiment 2 above.

While real-time control of the plant is performed through the center server 32 in Embodiment 2 described above, a similar process in Embodiment 4 includes confirmation of termination of real-time control.

The operation of the remote service offering system according to Embodiment 4 of the present invention will now be described with reference to the drawings.

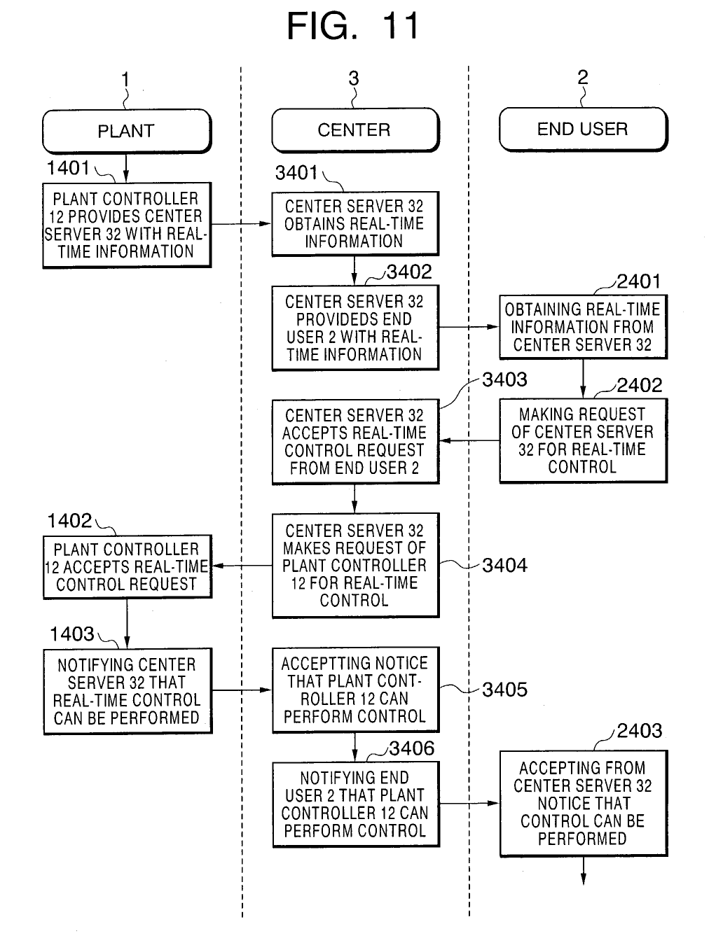

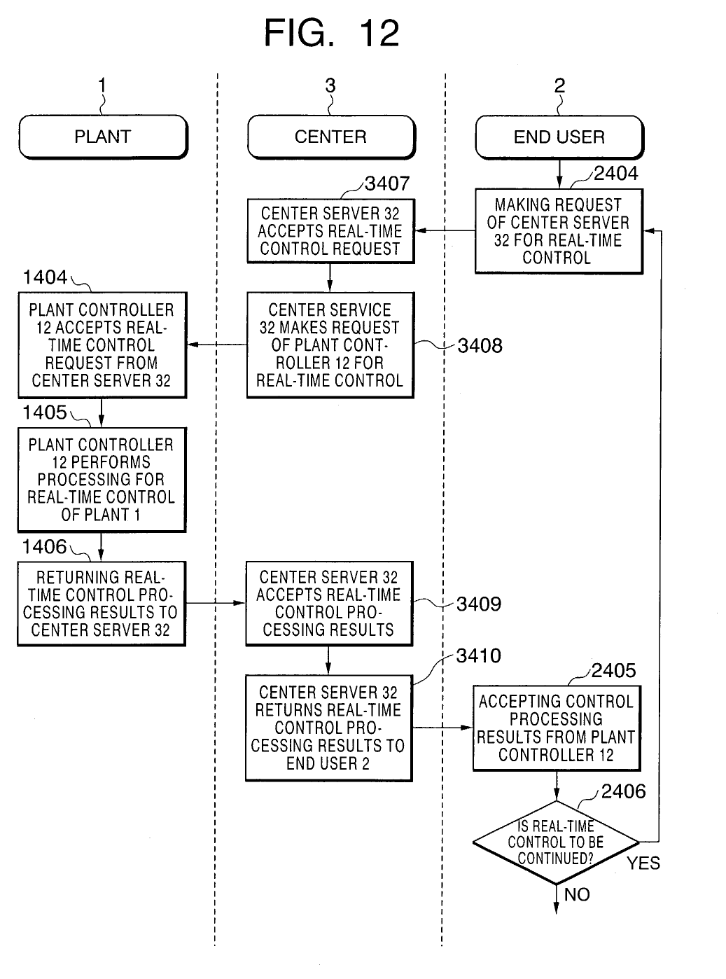

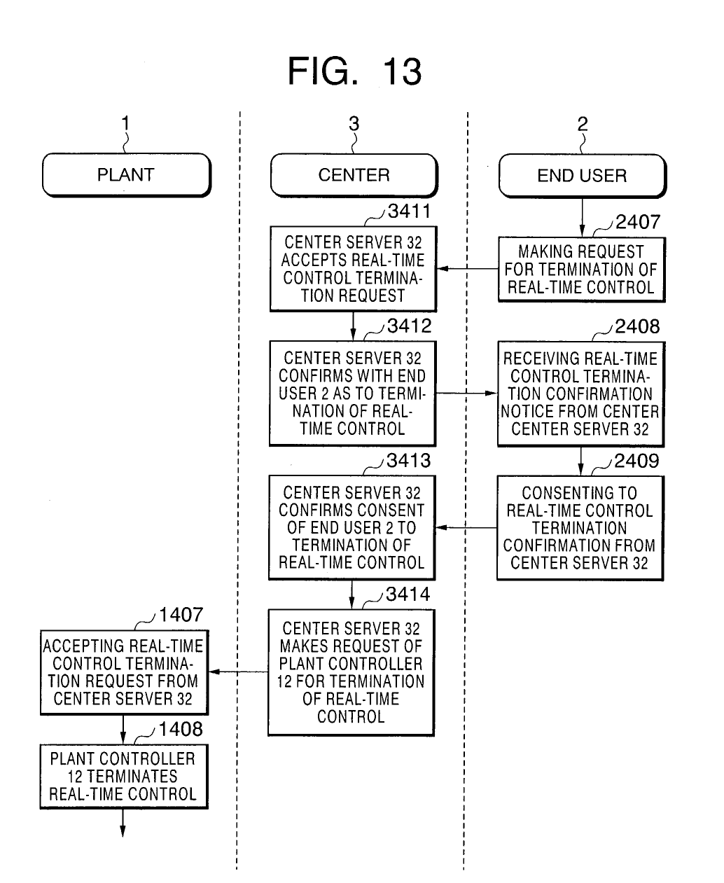

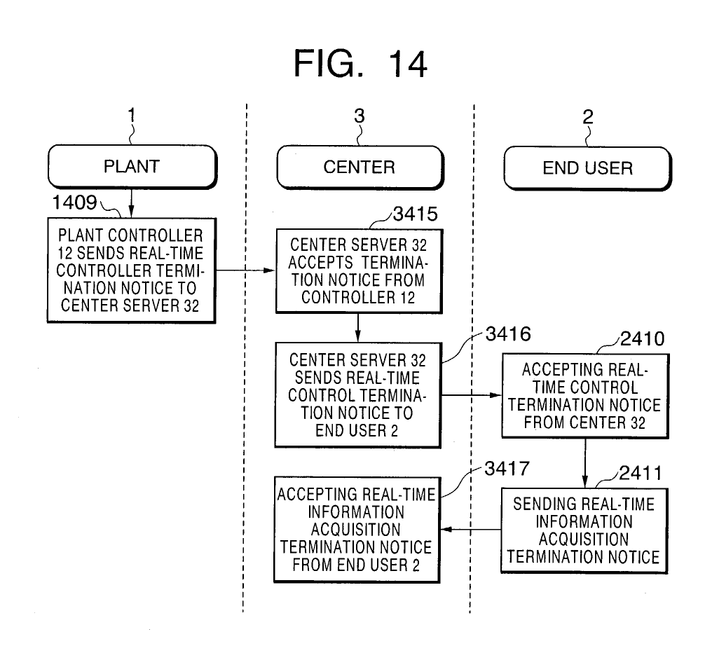

FIGS. 11 to 14 are flowcharts showing the operation of the remote service offering system according to Embodiment 4 of the present invention.

The operation before step 2401 is the same as that in Embodiment 1.

In step 2402 shown in FIG. 11, the end user 2 makes a request of the center server 32 for a start of real-time control.

In steps 3403 and 3404, the center server 32 accepts the real-time control start request from the end user 2 and makes a request of the plant controller 12 for real-time control.

In steps 1402 and 1403, the plant controller 12 accepts the real-time control request from the center server 32 and notifies the center server 32 that real-time control can be performed.

In steps 3405 and 3406, the center server 32 accepts from the plant controller 12 the notice that the real-time control can be performed, and notifies the end user 2 that real-time control can be performed.

In steps 2403 and 2404, the end user 2 accepts from the center server 32 the notice that the real-time control can be performed, and makes a request of the center server 32 for real-time control.

In steps 3407 and 3408, the center server 32 accepts the real-time control request from the end user 2 and makes a request of the plant controller 12 for real-time control.

In steps 1404 to 1406, the plant controller 12 accepts the real-time control request from the center server 32 and performs real-time control processing on the plant 1. The plant controller 12 also notifies the center server 32 of the results of real-time control processing.

In steps 3409 and 3410, the center server 32 accepts the results of real-time control processing from the plant controller 12 and notifies the end user 2 of the results of real-time control processing.

In steps 2405 to 2407, the end user 2 accepts the results of real-time control processing from the plant controller 2. If real-time control is to be continued, the end user 2 makes the process return to step 2404. If real-time control is to be stopped, the end user 2 makes a request of the center server 32 for termination of real-time control.

In steps 3411 and 3412, the center server 32 accepts the real-time control termination request from the end user 2 and notifies the end user 2 of the confirmation of the termination of real-time control.

In steps 2408 and 2409, the end user 2 receives the real-time control termination confirmation notice from the center server 32 and consents to the real-time control termination confirmation from the center server 32.

In steps 3413 and 3414, the center server 32 confirms the consent to the real-time control termination of the end user 2 and makes a request of the plant controller 12 for termination of real-time control.

In steps 1407 to 1409, the plant controller 12 accepts the real-time control termination request from the center server 32 and terminates the real-time control. The plant controller 12 also notifies the center server 32 of the termination of real-time control.

In steps 3415 and 3416, the center server 32 accepts the real-time control termination notice from the plant controller 12 and notifies the end user 2 of the termination of real-time control.

In steps 2410 and 2411, the end user 2 accepts the real-time control termination notice from the center server 32. After this operation, the process returns to the above-described operation of Embodiment 1.

Through the above-described procedure, all kinds of control selected by the end user 2 can be controlled via the center server 32 in the center 3. Also, all kinds of control can be handled via the center server 32. Further, it is possible to surely terminate the real-time control by performing an operation for confirmation of the real-time control termination upon the real-time control termination.

Embodiment 5

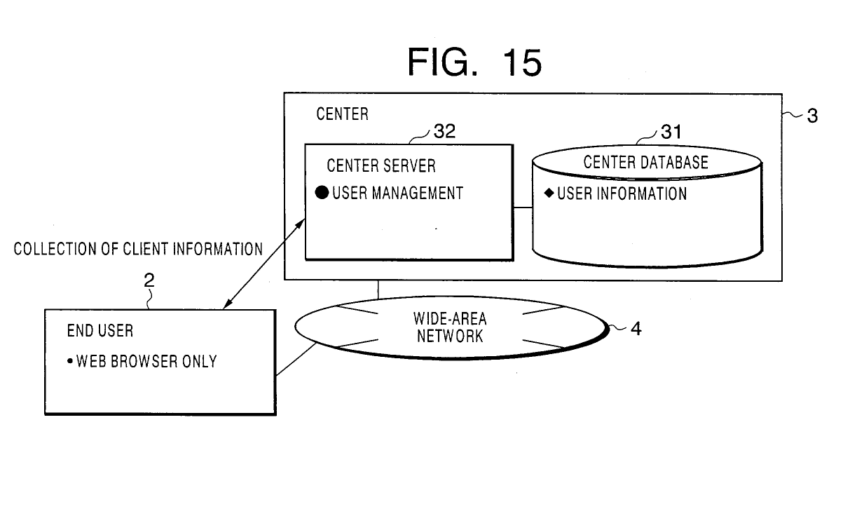

A remote service offering system according to Embodiment 5 of the present invention will be described with reference to the drawings. FIG. 15 is a diagram showing a configuration of the remote service offering system according to Embodiment 5 of the present invention.

The system shown in FIG. 15 includes an end user 2 who has a personal computer (PC) having functions corresponding to the functions of a Web browser or the like, a center 3 having a function of exchanging information with the end user 2, and a wide-area network 4 in which the end user 2 and the center 3 are connected.

The system shown in FIG. 15 also includes a center database 31 which holds user information of the end user 2, and service information for the end user 2, and a center server 32 which manages various kinds of service.

The center 3 has the center database 31 and the center server 32, which are respectively connected to the wide-area network 4 along with the end user 2. Thus, the center server 32 can provide information according to user information to the end user 2.

The operation of the remote service offering system according to Embodiment 5 of the present invention will now be described with reference to the drawings.

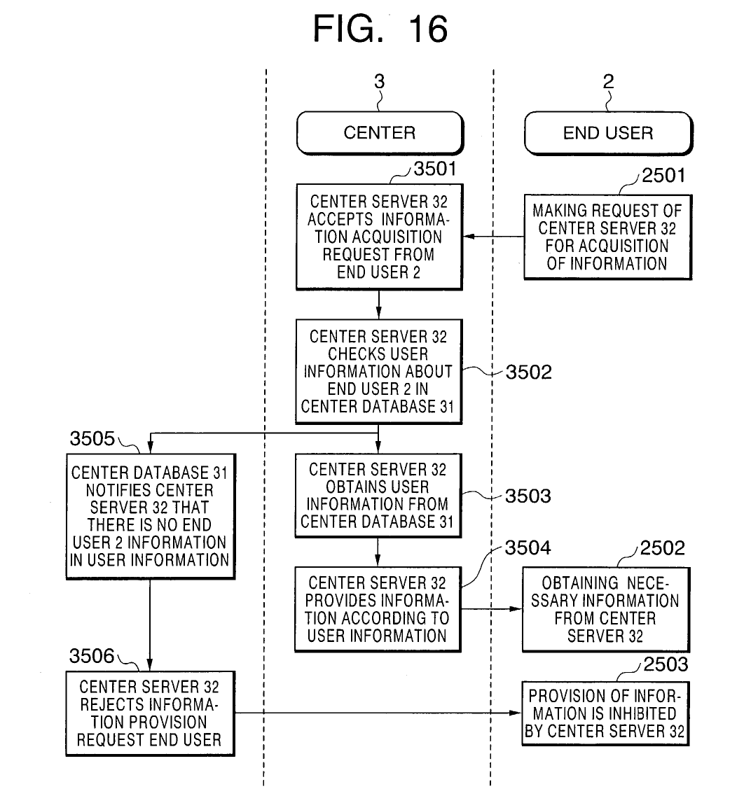

FIG. 16 is a flowchart showing the operation of the remote service offering system according to Embodiment 5 of the present invention.

In step 2501 shown in FIG. 16, the end user 2 makes a request of the center server 32 for the information acquisition.

In steps 3501 to 3504, the center server 32 accepts the information acquisition request from the end user 2 and refers to the center database 31 for the user information of the end user 2. The center server 32 obtains user information from the center database 31 and provides the information to the end user 2 according to the user information.

In step 2502, the end user 2 acquires the necessary information from the center server 32.

On the other hand, in steps 3505 and 3506, if there is no user information for the end user 2 in the center database 31, the center database 31 notifies the center server 32 of nonexistence of the corresponding user information. The center server 32 then rejects the information provision request from the end user 2.

In step 2503, provision of information to the end user 2 is stopped by the center server 32.

Embodiment 6

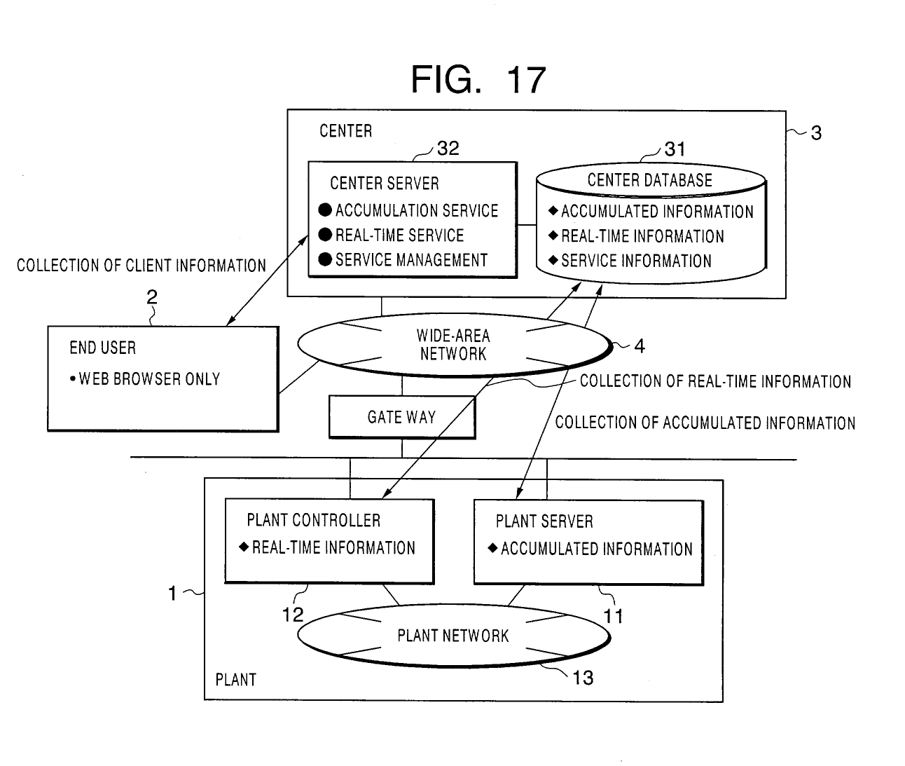

A remote service offering system according to Embodiment 6 of the present invention will be described with reference to the drawings. FIG. 17 is a diagram showing a configuration of the remote service offering system according to Embodiment 6 of the present invention.

The system shown in FIG. 17 includes a plant 1 in operation, an end user 2 who owns the plant and who has a personal computer (PC) having functions corresponding to the functions of a Web browser or the like, a center 3 having a function of intervening in exchange of information between the plant 1 and the end user 2, and a wide-area network 4 such as Internet in which the plant 1, the end user 2 and the center 3 are connected.

The system shown in FIG. 17 also includes a plant server 11 having a function of storing accumulated information, a plant controller 12 having a function of holding real-time information, and a plant network 13 having a function of connecting the plant server 11 and the plant controller 12 in the plant 1.

The system shown in FIG. 17 also includes a center database 31 which holds information accumulated in the plant server 11 of the plant 1, real-time information obtained by the plant controller 12, and service information for the end user 2, and a center server 32 which manages various kinds of service.

The plant server 11 and the plant controller 12 provided in the plant 1 and the center database 31 and the center server 32 provided in the center 3 are respectively connected to the wide-area network 4 along with the end user 2. These system components enable a remote service to be offered. All pieces of accumulated information are processed via the center (as is the same as in Embodiment 1 and, therefore, the description for this processing will not be repeated). Real-time information is exchanged between the user 2 and the plant controller 12. However, the information acquisition time is controlled by the center server 32.

The operation of the remote service offering system according to Embodiment 6 of the present invention will now be described with reference to the drawings.

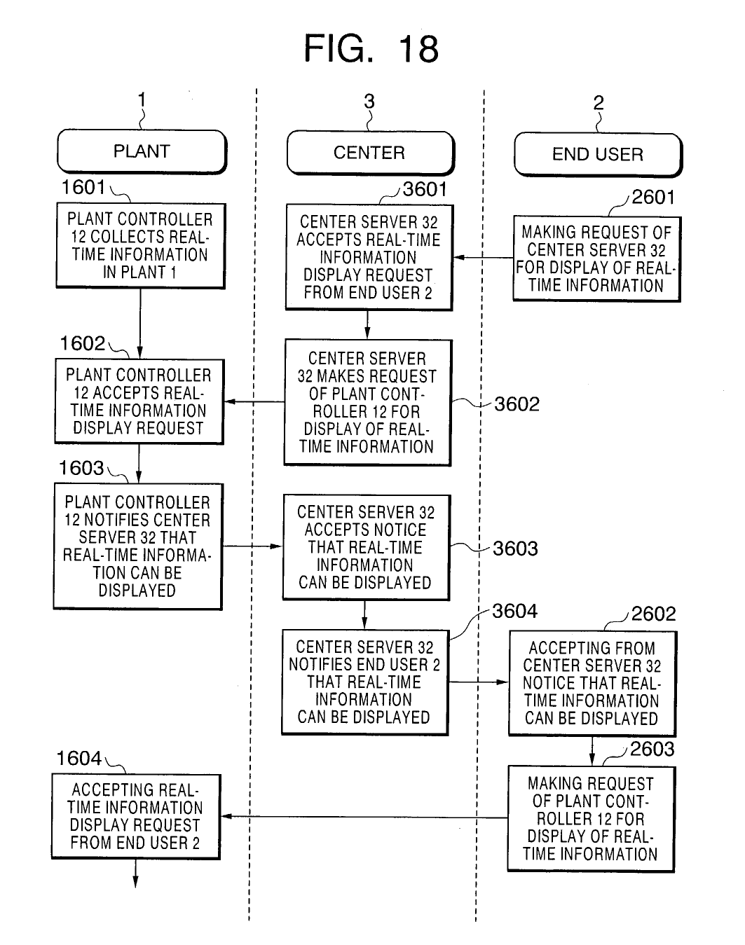

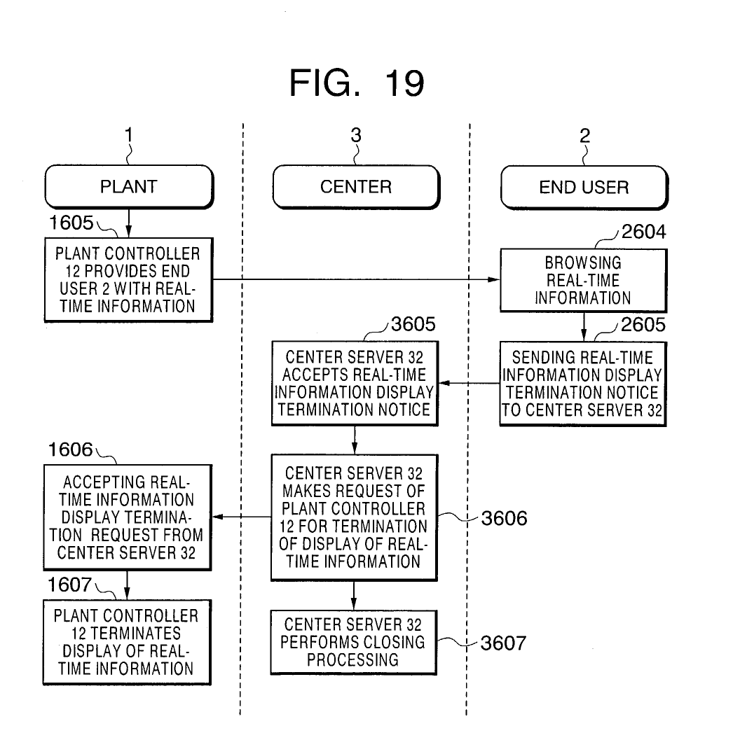

FIGS. 18 and 19 are flowcharts showing the operation of the remote service offering system according to Embodiment 6 of the present invention.

In step 1601 shown in FIG. 18, the plant controller 12 collects real-time information in the plant 1.

In step 2601, the end user 2 makes a request of the center server 32 for display of real-time information.

In steps 3601 and 3602, the center server 32 accepts the real-time information display request from the end user 2 and makes a request of the plant controller 12 for display of real-time information.

In steps 1602 and 1603, the plant controller 12 accepts the real-time information display request from the center server 32 and notifies the center server 32 that the real-time control can be provided.

In steps 3603 to 3604, the center server 32 accepts from the plant controller 12 the notice that the real-time control can be provided and notifies the end user 2 that the real-time control can be displayed.

In steps 2602 and 2603, the end user 2 accepts from the center server 32 the notice that real-time information can be displayed, and makes a request of the plant controller 12 for provision of real-time information.

In steps 1604 and 1605, the plant controller 12 accepts the real-time information provision request from the end user 2 and provides real-time information to the end user 2.

In steps 2604 and 2605, the end user 2 browses the real-time information from the plant controller 12 and sends a notice of termination of display of the real-time information to the center server 32.

In steps 3605 to 3607, the center server 32 accepts the real-time information display termination notice from the end user 2 and makes a request of the plant controller 12 for termination of provision of real-time information. The center server 32 also performs closing processing.

In steps 1606 and 1607, the plant controller 12 accepts the real-time information provision termination request from the center server 32 and terminates the provision of real-time information.

Through the above-described procedure, processing of information can be performed by the center server 32 at all requests from the end user 2 in such a manner that accumulated information is processed via the center 3 and real-time information, which needs to be immediately processed, is directly processed between the plant 1 and the end user 2. However, even at the time of this direct processing, the information acquisition time, and the like are controlled by the center server 32.

Embodiment 7

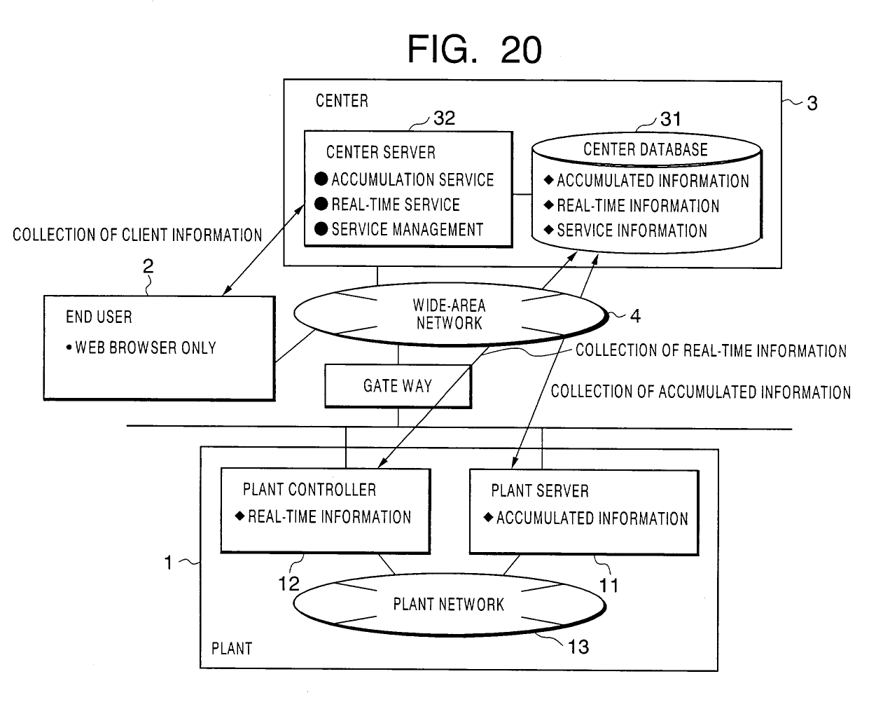

A remote service offering system according to Embodiment 7 of the present invention will be described with reference to the drawings. FIG. 20 is a diagram showing a configuration of the remote service offering system according to Embodiment 7 of the present invention.

The system shown in FIG. 20 includes a plant 1 in operation, an end user 2 who owns the plant and who has a personal computer (PC) having functions corresponding to the functions of a Web browser or the like, a center 3 having a function of intervening in exchange of information between the plant 1 and the end user 2, and a wide-area network 4 such as Internet in which the plant 1, the end user 2 and the center 3 are connected.

The system shown in FIG. 20 also includes a plant server 11 having a function of storing accumulated information, a plant controller 12 having a function of holding real-time information, and a plant network 13 having a function of connecting the plant server 11 and the plant controller 12 in the plant 1.

The system shown in FIG. 20 also includes a center database 31 which holds information accumulated in the plant server 11 of the plant 1, real-time information obtained by the plant controller 12, and service information for the end user 2, and a center server 32 which manages various kinds of service.

The plant server 11 and the plant controller 12 provided in the plant 1 and the center database 31 and the center server 32 provided in the center 3 are respectively connected to the wide-area network 4 along with the end user 2. These system components enable a remote service to be offered. All pieces of accumulated information are processed via the center (as is the same as in Embodiment 1 and, therefore, the description for this processing will not be repeated). Real-time information is exchanged between the user 2 and the plant controller 12. However, the information acquisition time is controlled by the center server 32.

The operation of the remote service offering system according to Embodiment 7 of the present invention will now be described with reference to the drawings.

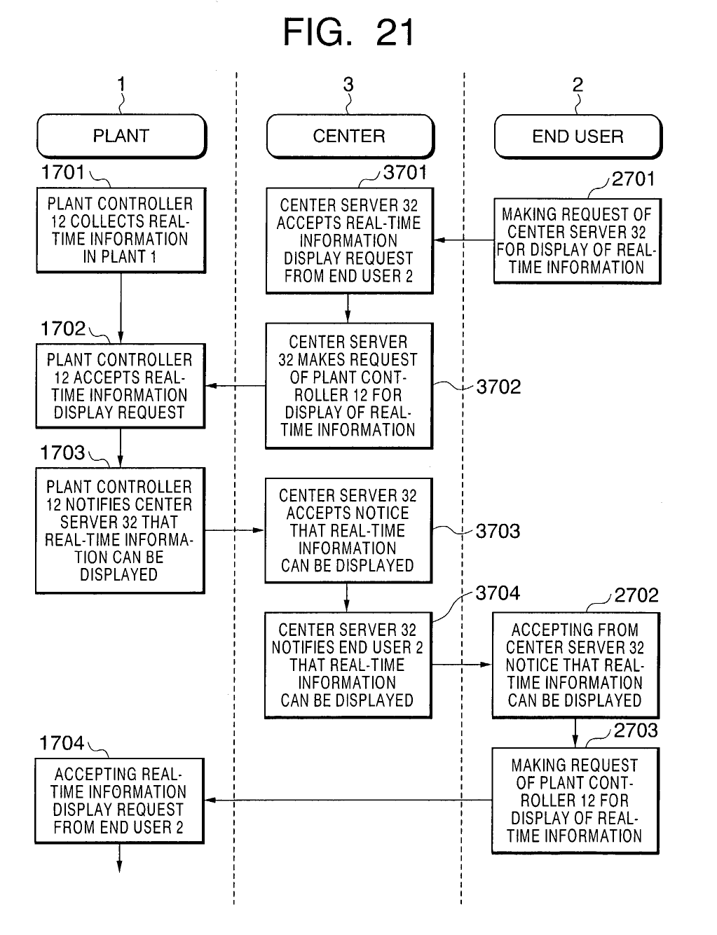

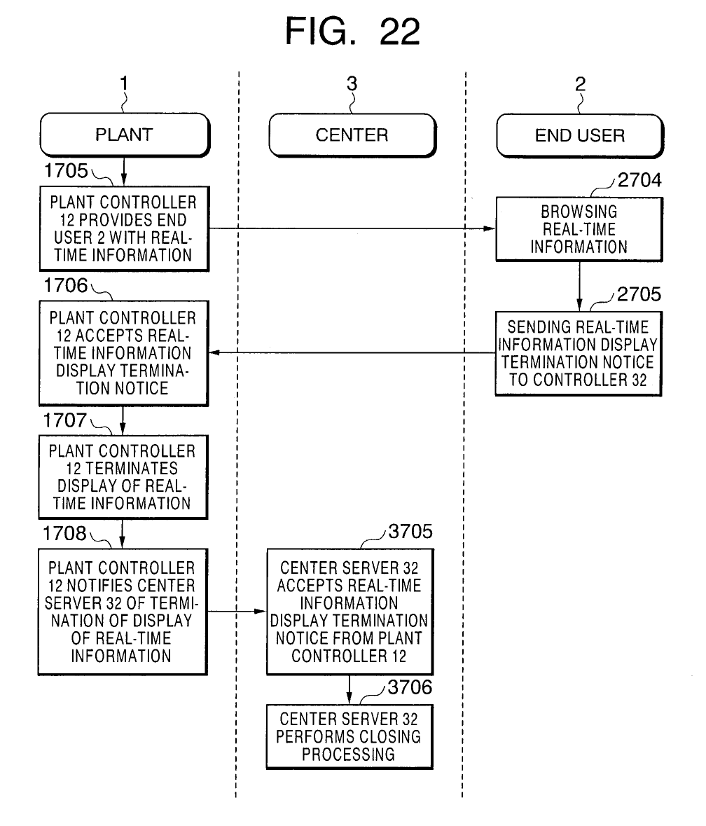

FIGS. 21 and 22 are flowcharts showing the operation of the remote service offering system according to Embodiment 7 of the present invention.

In step 1701 shown in FIG. 21, the plant controller 12 collects real-time information in the plant 1.

In step 2701, the end user 2 makes a request of the center server 32 for display of real-time information.

In steps 3701 and 3702, the center server 32 accepts the real-time information display request from the end user 2 and makes a request of the plant controller 12 for display of real-time information.

In steps 1702 and 1703, the plant controller 12 accepts the real-time information display request from the center server 32 and notifies the center server 32 that the real-time control can be displayed.

In steps 3703 and 3704, the center server 32 accepts from the plant controller 12 the notice that the real-time control can be displayed and notifies the end user 2 that the real-time control can be displayed.

In steps 2702 and 2703, the end user 2 accepts from the center server 32 the notice that real-time information can be displayed, and makes a request of the plant controller 12 for display of real-time information.

In steps 1704 and 1705, the plant controller 12 accepts the real-time information display request from the end user 2 and provides real-time information to the end user 2.

In steps 2704 and 2705, the end user 2 browses the real-time information from the plant controller 12 and sends a notice of termination of display of the real-time information to the plant controller 12.

In steps 1706 to 1708, the plant controller 12 accepts the real-time information display termination notice from the end user 2 and terminates display of real-time information and notifies the center server 32 of the termination of display of real-time information.

In steps 3705 to 3706, the center server 32 accepts the real-time information display termination notice from the plant controller 12. The center server 32 also performs closing processing.

Through the above-described procedure, processing of information can be performed by the center server 32 at all requests from the end user 2 in such a manner that accumulated information is processed via the center 3 and real-time information, which needs to be immediately processed, is directly processed between the plant 1 and the end user 2. However, even at the time of this direct processing, the information acquisition time and the like are controlled by the center server 32.

Embodiment 8

A remote service offering system according to Embodiment 8 of the present invention will be described with reference to the drawings. Note that, a configuration of the remote service offering system according to Embodiment 8 of the present invention is the same as that of Embodiment 1 of the present invention.

Embodiment 8 is characterized by the combination of the method in which “while control of the plant is started through the center server 32, control of the plant is terminated through the plant and information on termination of plant control is sent via the center server 32” and the method of Embodiment 1 in which “all pieces of information can be handled via the center server 32”. With respect to confirmation of termination, both a case where “no confirmation is made when real-time control is terminated” as in Embodiment 2 and a case where “a confirmation is made when real-time control is terminated” as in Embodiment 4 are conceivable. Embodiment 8 is assumed to conform to Embodiment 4. However, the procedure in Embodiment 2 may alternatively be used.

The operation of the remote service offering system according to Embodiment 8 of the present invention will now be described with reference to the drawings.

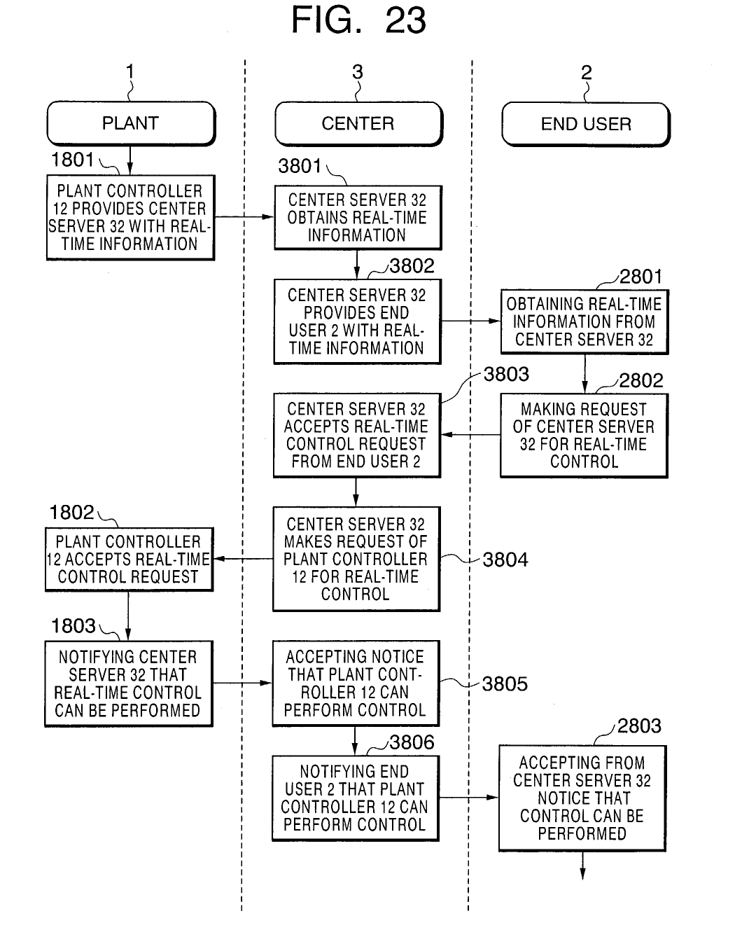

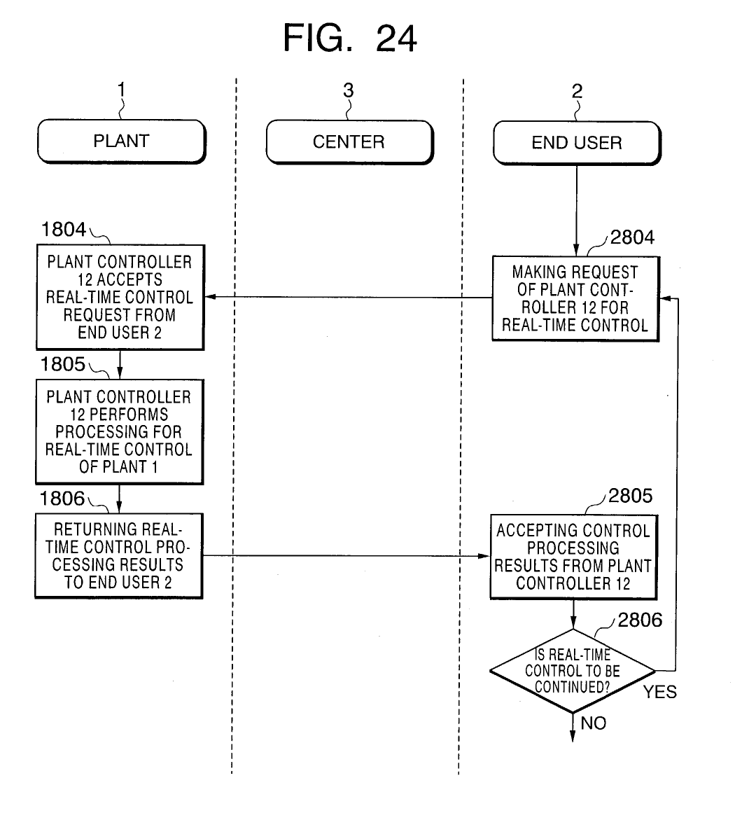

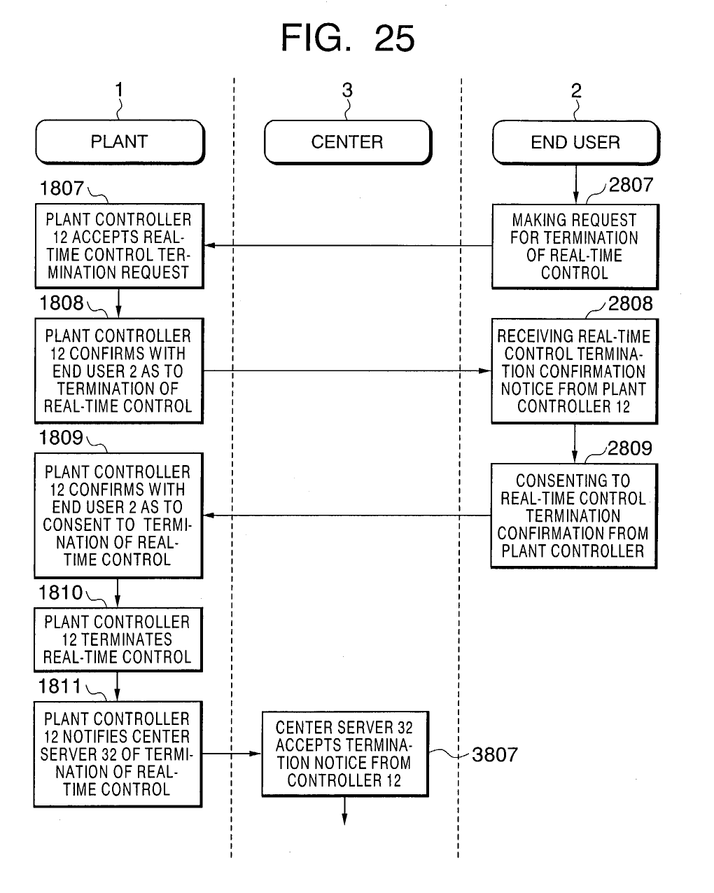

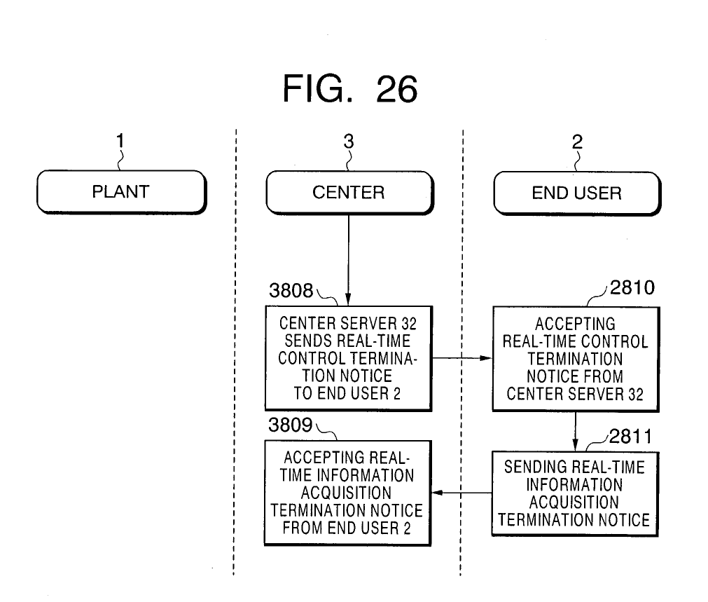

FIGS. 23 to 26 are flowcharts showing the operation of the remote service offering system according to Embodiment 8 of the present invention.

The operation before step 2801 shown in FIG. 23 is the same as that in Embodiment 1.

In step 2802, the end user 2 makes a request of the center server 32 for a start of real-time control.

In steps 3803 and 3804, the center server 32 accepts the real-time control start request from the end user 2 and makes a request of the plant controller 12 for real-time control.

In steps 1802 and 1803, the plant controller 12 accepts the real-time control request from the center server 32 and notifies the center server 32 that real-time control can be performed.

In steps 3805 and 3806, the center server 32 accepts from the plant controller 12 the notice that the real-time control can be performed, and notifies the end user 2 that real-time control can be performed.

In steps 2803 and 2804, the end user 2 accepts from the center server 32 the notice that the real-time control can be performed, and makes a request of the plant controller 12 for real-time control.

In steps 1804 to 1806, the plant controller 12 accepts the real-time control request from the end user 2 and performs real-time control processing on the plant 1. The plant controller 12 also notifies the end user 2 of the results of real-time control processing.

In steps 2805 to 2807, the end user 2 accepts the results of real-time control processing from the plant controller 12. If real-time control is to be continued, the end user 2 makes the process return to step 2804. If real-time control is to be stopped, the end user 2 makes a request of the plant controller 12 for termination of real-time control.

In steps 1807 and 1808, the plant controller 12 accepts the real-time control termination request from the end user 2. The plant controller 12 also notifies the end user 2 of the confirmation of the termination of real-time control.

In steps 2808 and 2809, the end user 2 receives the real-time control termination confirmation notice from the plant controller 12 and consents to the real-time control termination confirmation from the plant controller 12.

In steps 1809 to 1811, the plant controller 12 confirms the consent of the end user 2 to termination of real-time control, and terminates real-time control. The plant controller 12 also notifies the center server 32 of the termination of real-time control.

In steps 3807 and 3808, the center server 32 accepts the real-time control termination notice from the plant controller 12 and notifies the end user 2 of the termination of real-time control.

In steps 2810 and 2811, the end user 2 accepts the real-time control termination notice from the center server 32. After this operation, the process returns to the above-described operation of Embodiment 1.

Through the above-described procedure, all kinds of control selected by the end user 2 can be controlled through the center server 32 in the center 3. Also, control of the plant is started through the center server 32, control of the plant is terminated through the plant, and information on termination of plant control is sent via the center server 32. If control is performed in this manner, the information exchange load on the center server 32 can be reduced and further, the speed of plant control response to the plant control request from the end user 2 can be increased.

Embodiment 9

A remote service offering system according to Embodiment 9 of the present invention will be described with reference to the drawings. Note that, a configuration of the remote service offering system according to Embodiment 9 of the present invention is the same as that of Embodiment 1 of the present invention.

Embodiment 9 is characterized by the combination of the method in which “control of the plant is started and terminated through the center server 32 but intermediate control is performed without intervention of the center server 32” and the method of Embodiment 1 in which “all pieces of information can be handled via the center server 32”. With respect to confirmation of termination, both a case where “no confirmation is made when real-time control is terminated” as in Embodiment 2 and a case where “a confirmation is made when real-time control is terminated” as in Embodiment 4 are conceivable. Embodiment 9 is assumed to conform to Embodiment 4. However, the procedure in Embodiment 2 may alternatively be used.

The operation of the remote service offering system according to Embodiment 9 of the present invention will now be described with reference to the drawings.

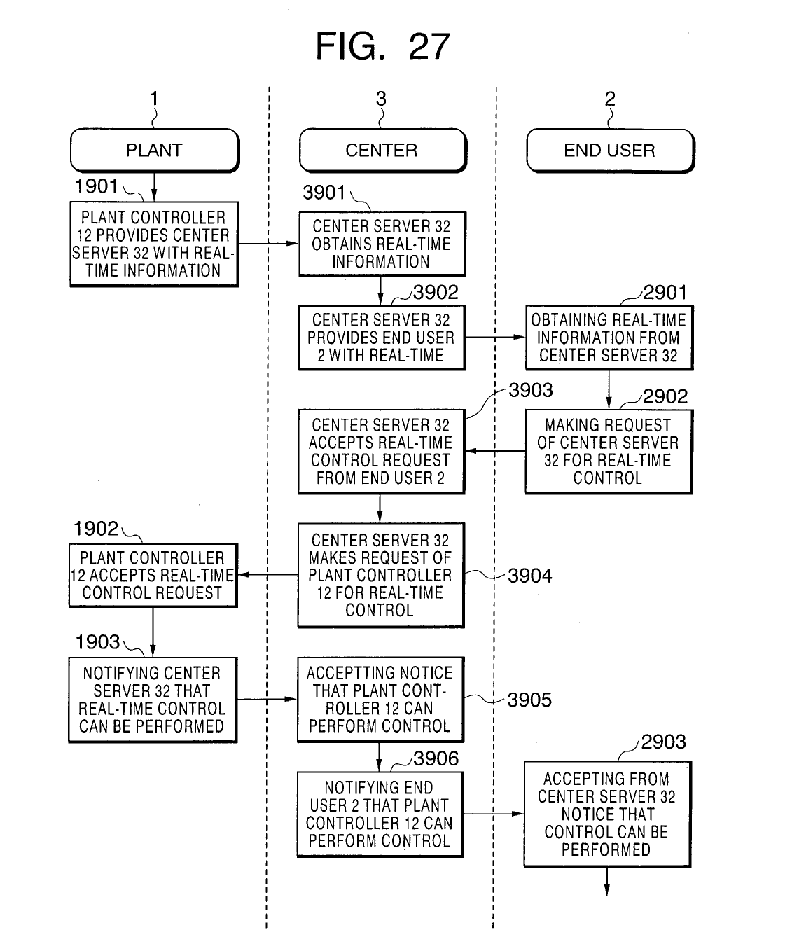

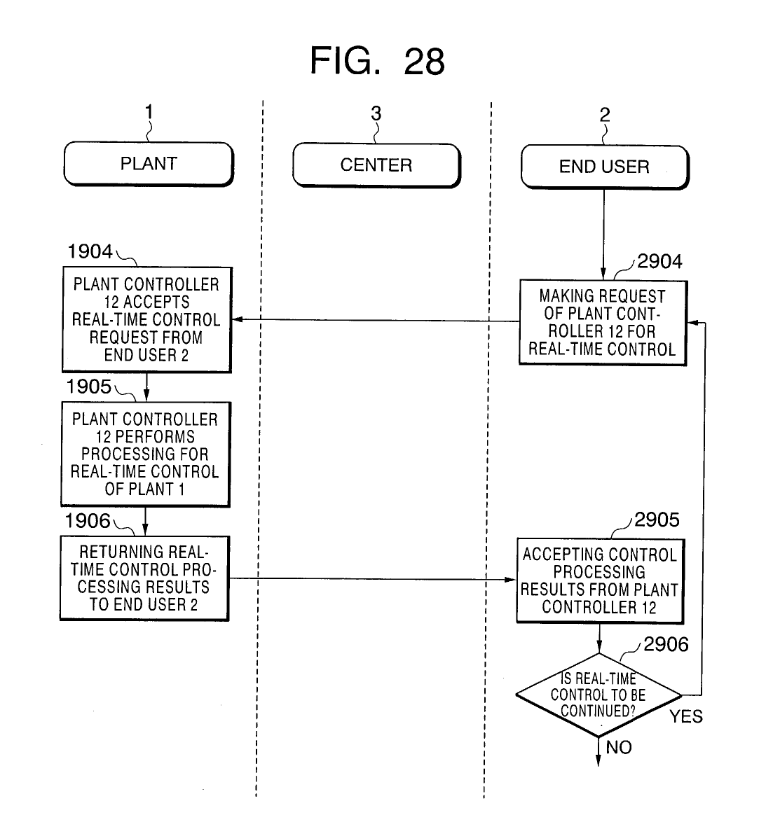

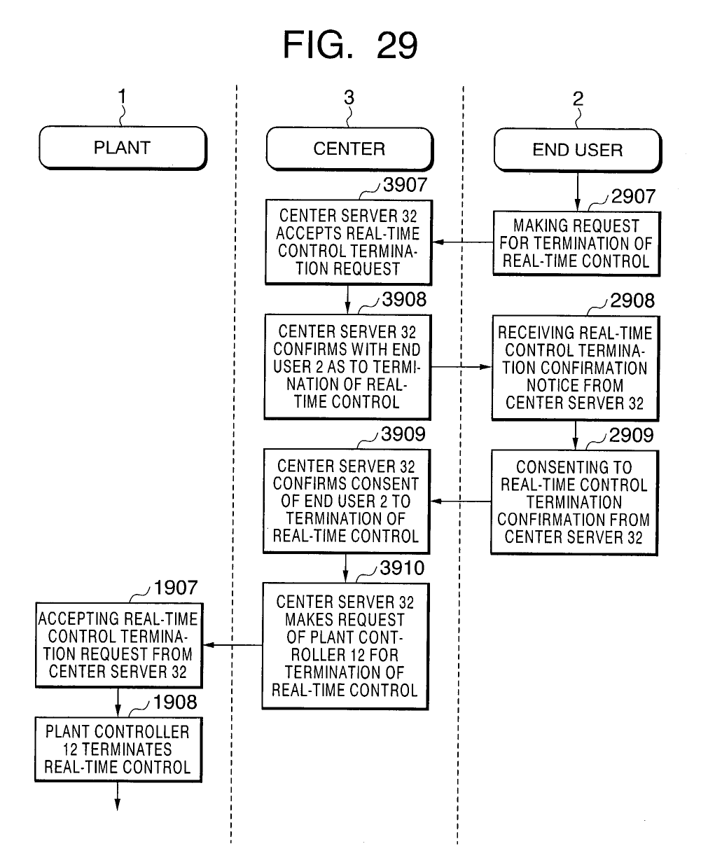

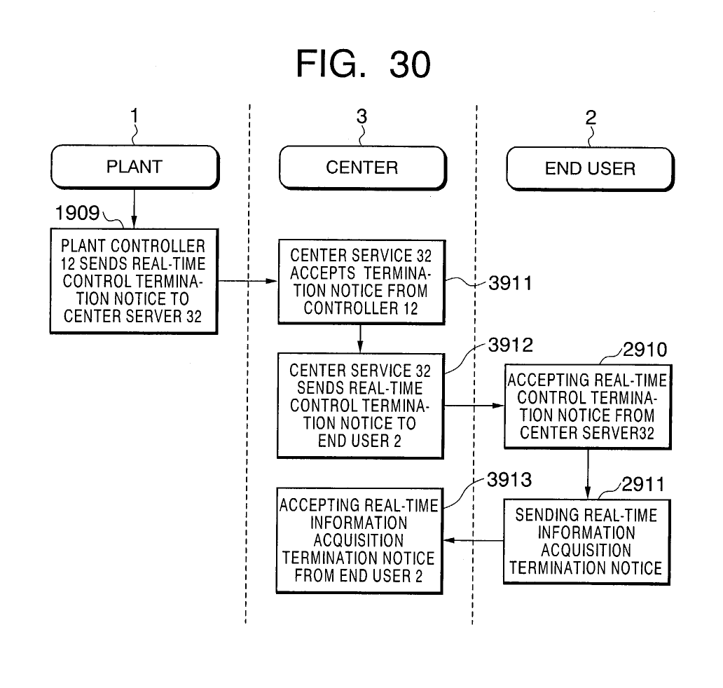

FIGS. 27 to 30 are flowcharts showing the operation of the remote service offering system according to Embodiment 9 of the present invention.

The operation before step 2901 shown in FIG. 27 is the same as that in Embodiment 1.

In step 2902, the end user 2 makes a request of the center server 32 for a start of real-time control.

In steps 3903 and 3904, the center server 32 accepts the real-time control start request from the end user 2 and makes a request of the plant controller 12 for real-time control.

In steps 1902 and 1903, the plant controller 12 accepts the real-time control request from the center server 32 and notifies the center server 32 that real-time control can be performed.

In steps 3905 and 3906, the center server 32 accepts from the plant controller 12 the notice that the real-time control can be performed, and notifies the end user 2 that real-time control can be performed.

In steps 2903 and 2904, the end user 2 accepts from the center server 32 the notice that the real-time control can be performed, and makes a request of the plant controller 12 for real-time control.

In steps 1904 to 1906, the plant controller 12 accepts the real-time control request from the end user 2 and performs real-time control processing on the plant 1. The plant controller 12 also notifies the end user 2 of the results of real-time control processing.

In steps 2905 to 2907, the end user 2 accepts the results of real-time control processing from the plant controller 12. If real-time control is to be continued, the end user 2 makes the process return to step 2904. If real-time control is to be stopped, the end user 2 makes a request of the center server 32 for termination of real-time control.

In steps 3907 and 3908, the center server 32 accepts the real-time control termination request from the end user 2 and notifies the end user 2 of the confirmation of the termination of real-time control.

In steps 2908 and 2909, the end user 2 receives the real-time control termination confirmation notice from the center server 32 and consents to the real-time control termination confirmation from the center server 32.

In steps 3909 and 3910, the center server 32 confirms the consent of the end user 2 to termination of real-time control. The center server 32 makes a request of the plant controller 12 for the termination of real-time control.

In steps 1907 to 1909, the plant controller 12 accepts the real-time control termination notice from the center server 32 and terminates the real-time control. Also, the plant controller 12 notifies the center server 32 of the termination of real-time control.

In steps 3911 and 3912, the center server 32 accepts the real-time control termination notice from the plant controller 12, and notifies the end user 2 of the termination of real-time control.

In steps 2910 and 2911, the end user 2 accepts the real-time control termination notice from the center server 32. After this operation, the process returns to the above-described operation of Embodiment 1.

Through the above-described procedure, all kinds of control selected by the end user 2 can be controlled through the center server 32 in the center 3. Also, control of the plant is started and terminated through the center server 32, and intermediate control of the plant is performed without intervention of the center server 32. If control is performed in this manner, the information exchange load on the center server 32 can be reduced and the speed of plant control response to the plant control request from the end user 2 can be increased.

Embodiment 10

A remote service offering system according to Embodiment 10 of the present invention will be described with reference to the drawings. Note that, a configuration of the remote service offering system according to Embodiment 10 of the present invention is basically the same as that of Embodiment 1 of the present invention.

In this remote service offering system, all pieces of information are managed in the center server 32. A specific example of service charges collected for information provided by the center server 32 (in remote maintenance and monitoring) and information accepted from the end user 2 (for remote control) will be described.

When a service is offered, five charging parameters shown below are set:

(1) distance, (2) connection time, (3) kind of information, (4) amount of information, and (5) kind of user.

It is thought that, in general, a charge is determined by these five charging parameters set as independent variables. If Y represents the charge; X₁, the distance; X₂, the connection time; X₃, the kind of information; X₄, the amount of information; and X₅, the kind of user, the following expression is formed:

Y=f (X₁, X₂, X₃, X₄, X₅)

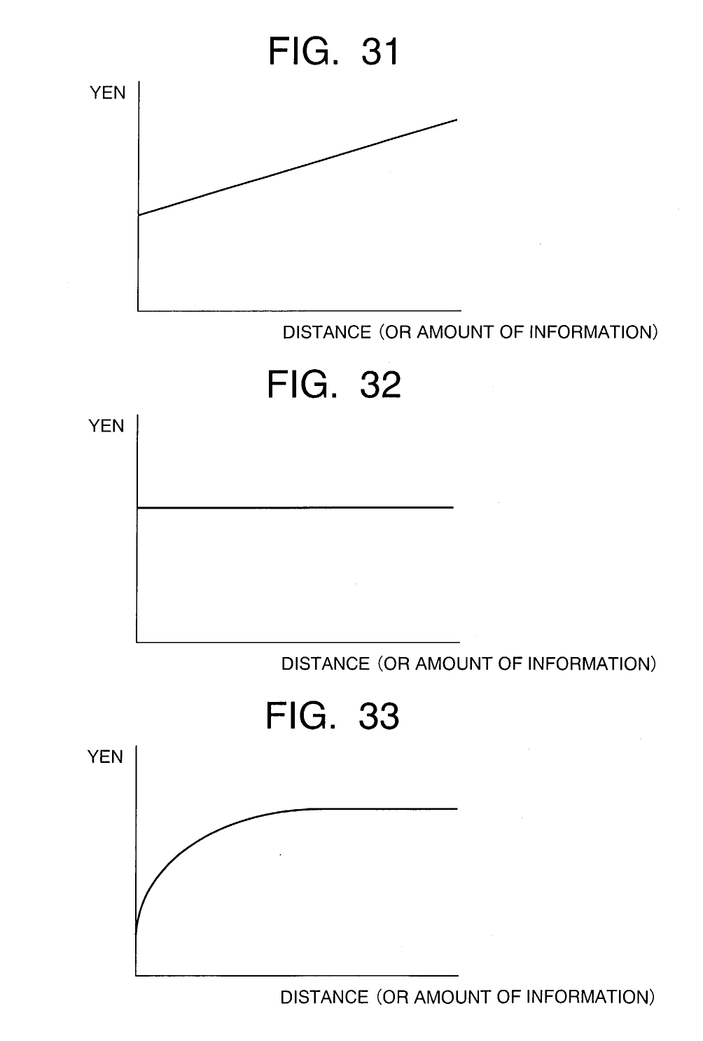

The charge with respect to the distance will be considered while assuming that the other factors are uniquely determined in advance. That is, an expression Y=f(X₁) is obtained. For example, a relationship between the charge and the distance is assumed to be as shown in one of FIGS. 31 to 36.

Charging will be described briefly with reference to FIGS. 31 to 36.

FIG. 31 shows a case where the relationship between the charge (yen) and the distance is expressed by a linear function (having a positive slope and a positive intercept).

FIG. 32 shows a case where the relationship between the charge (yen) and the distance is constant.

FIG. 33 shows a case where the relationship between the charge (yen) and the distance is expressed by such a function that the differential of the first order gradually approaches zero from a certain positive value with respect to the distance or the differential of the first order is finally zero.

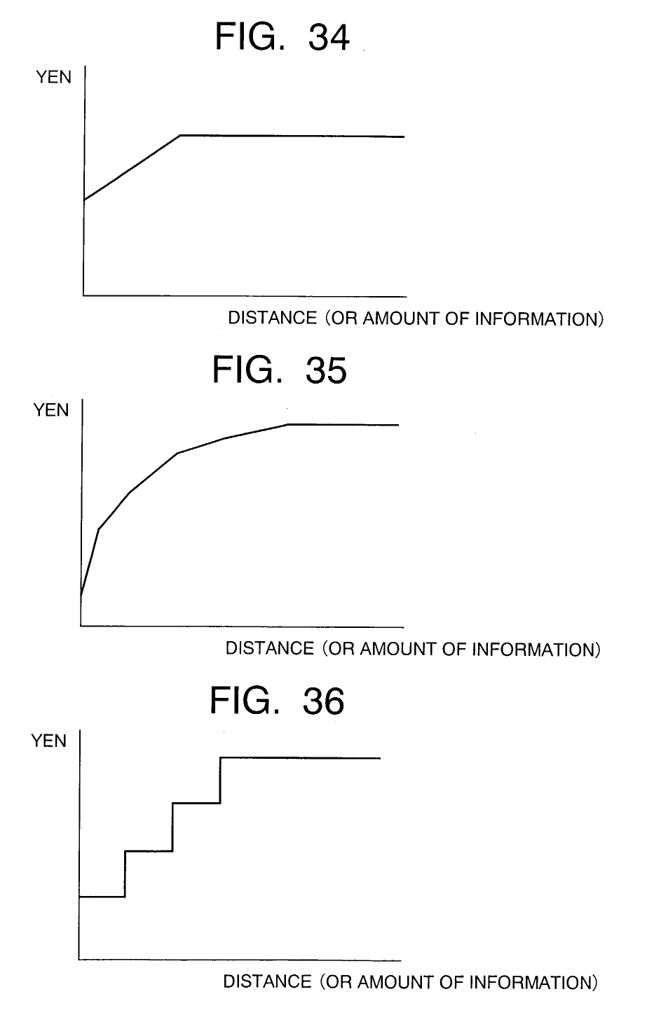

FIG. 34 shows a case where the relationship between the charge (yen) and the distance is expressed by a linear function (having a positive slope and a positive intercept) at an initial stage with respect to the distance and is constant at the following stage.

FIG. 35 shows a case where the relationship between the charge (yen) and the distance is expressed by a set of linear functions (each having a positive slope) consecutively set in such a manner that the slope is gradually reduced with respect to the distance.

FIG. 36 shows a case where the relationship between the charge (yen) and the distance is such that the charge is increased stepwise with respect to the distance.

The charge with respect to the amount of information will next be considered while assuming that the other factors are uniquely determined in advance. That is, an expression Y=f (X₄) is obtained. For example, the charge with respect to the amount of information is assumed to be as shown in one of FIGS. 31 to 36, similarly to the charge with respect to the distance.

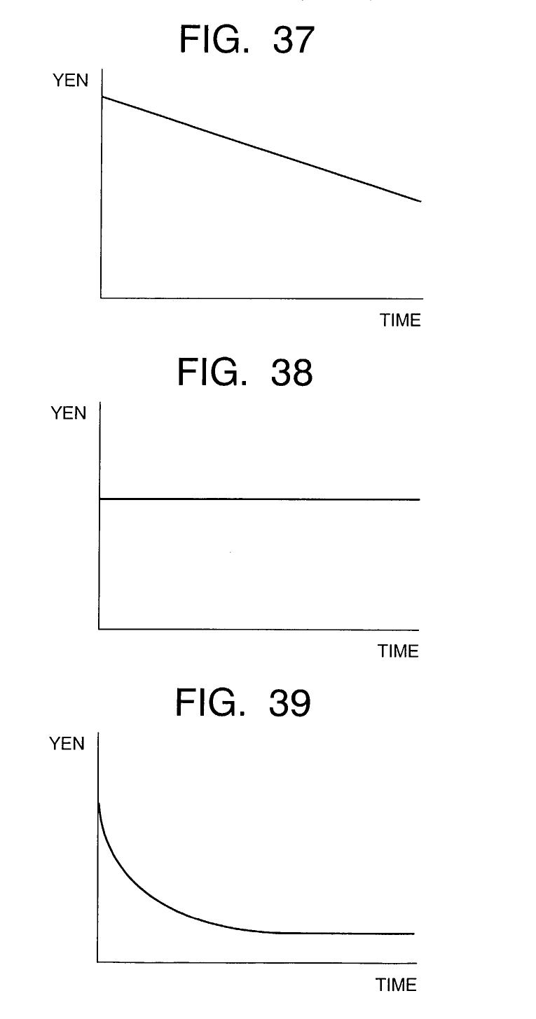

The charge with respect to the connection time will next be considered while assuming that the other factors are uniquely determined in advance. That is, an expression Y=f(X₂) is obtained. For example, the charge with respect to the connection time is assumed to be as shown in one of FIGS. 37 to 42.

Charging will be described briefly with reference to FIGS. 37 to 42.

FIG. 37 shows a case where the relationship between the charge (yen) and the connection time is expressed by a linear function (having a negative slope and a positive intercept).

FIG. 38 shows a case where the relationship between the charge (yen) and the connection time is constant.

FIG. 39 shows a case where the relationship between the charge (yen) and the connection time is expressed by such a function that the differential of the first order gradually approaches zero from a certain negative value with respect to the connection time or the differential of the first order is finally zero.

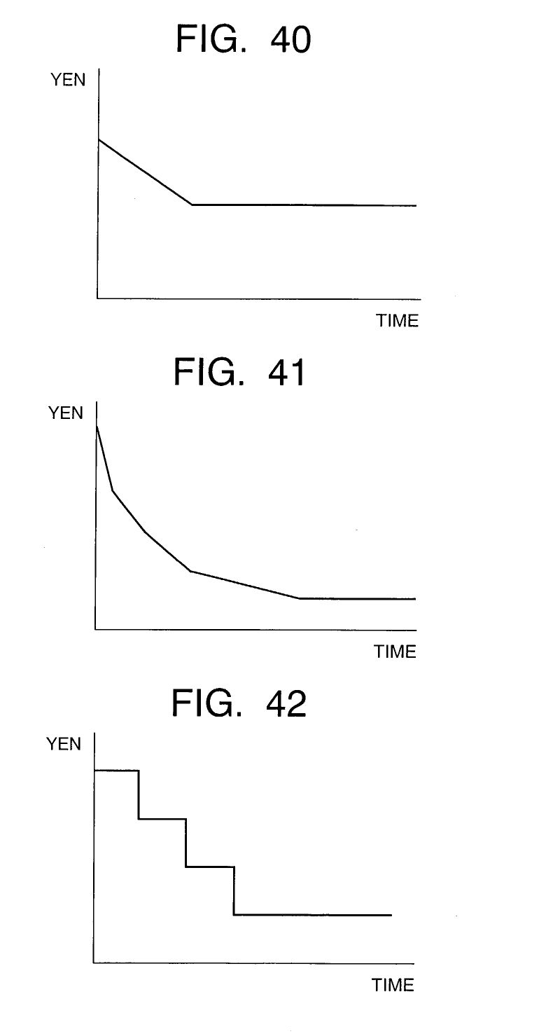

FIG. 40 shows a case where the relationship between the charge (yen) and the connection time is expressed by a linear function (having a negative slope and a positive intercept) at an initial stage with respect to the connection time and is constant at the following stage.

FIG. 41 shows a case where the relationship between the charge (yen) and the connection time is expressed by a set of linear functions (each having a negative slope) consecutively set in such a manner that the slope is gradually increased with respect to the connection time.

FIG. 42 shows a case where the relationship between the charge (yen) and the connection time is such that the charge is reduced stepwise with respect to the connection time.

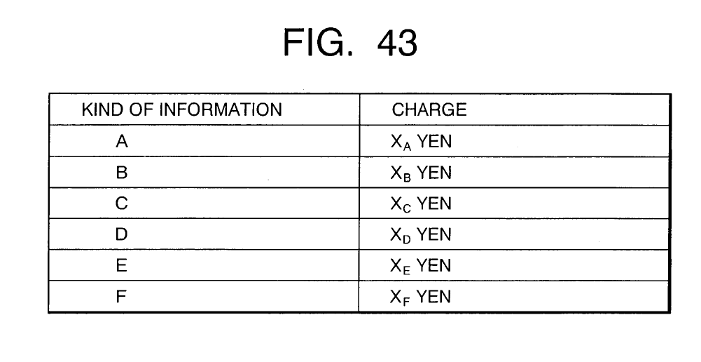

The charge with respect to the kind of information will next be considered while assuming that the other factors are uniquely determined in advance. The relationship between the charge and the kind of information is assumed to be as shown in the table of FIG. 43 and the charge is collected according to the service combination.

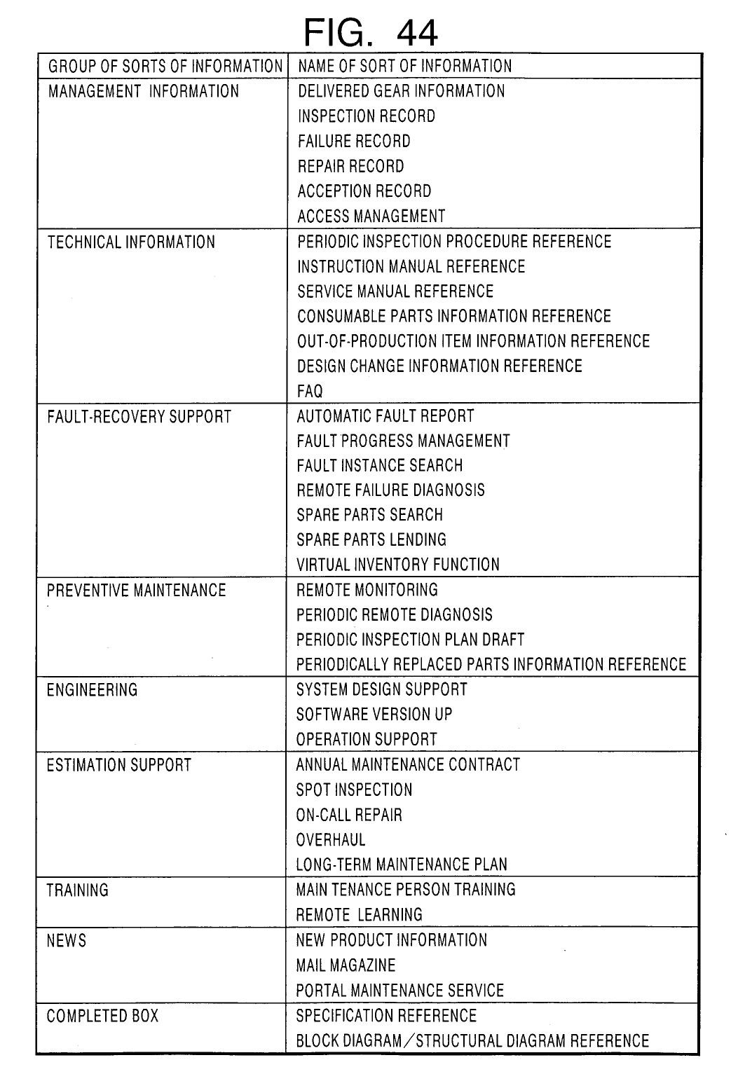

FIG. 44 shows an example of kinds of service. Other examples of kinds of information are a CTI function, an asset management function, a data analysis support function, and a training simulation function.

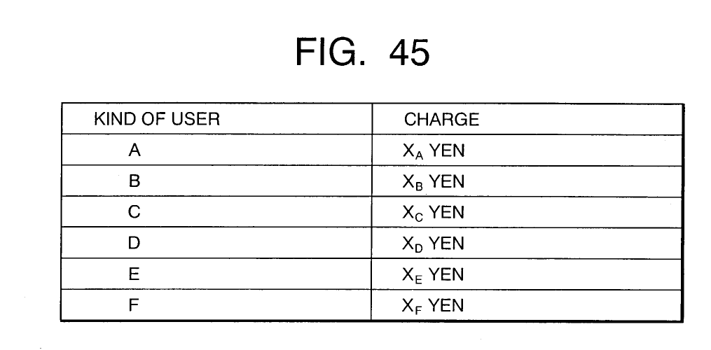

The charge with respect to the kind of user will next be considered while assuming that the other factors are uniquely determined in advance. The relationship between the charge and the kind of user is assumed to be as shown in the table of FIG. 45. Here, the kind of user may be defined, for example, as distinction of the users based on the scale of the plant owned by each user, which is set at the time of contraction.

While charging has been described while assuming that the values other than one charging parameter are uniquely determined, in other words, this means that the charge is set according to the interrelationships among the above-described factors.

While the charging parameters are assumed to be independent of each other, the kind of information and the kind of user may be determined depending on the amount of information obtained, the distance between the plant 1 and the center 3, the connection time, etc.

A method relating to the form of user contract may be used in which charging is performed according to a selection made by a user from charging systems upon the collection of charges using the charging parameters in different ways.

Embodiment 11

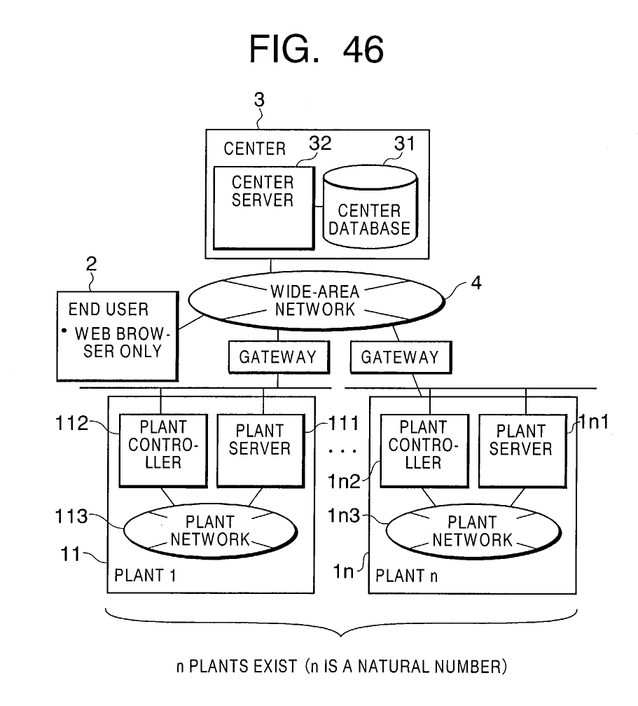

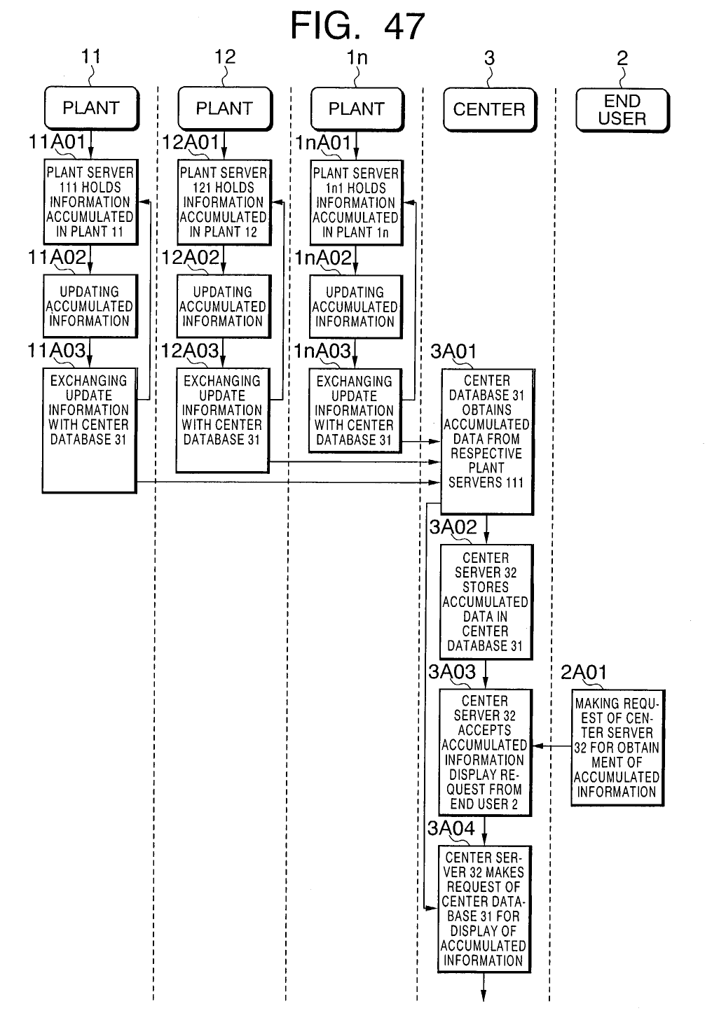

A remote service offering system according to Embodiment 11 of the present invention will be described with reference to the drawings. FIG. 46 is a diagram showing a configuration of the remote service offering system according to Embodiment 11 of the present invention. The same reference numerals in the drawings designate components identical or equivalent to each other.

The remote service offering system shown in FIG. 46 includes a plant 11 in operation, an end user 2 who owns the plant 11 and who has a personal computer (PC) having functions corresponding to the functions of a Web browser or the like, a center 3 having a function of intervening in exchange of information between the plant 11 and the end user 2, and a wide-area network 4 in which the plant 11, the end user 2 and the center 3 are connected. Further, n plants (n is a natural number) exist on the wide-area network 4, where n-th plant is 1n.

The plant 11 shown in FIG. 46 also includes a plant server 111 having a function of storing accumulated information, a plant controller 112 having a function of holding real-time information, and a plant network 113 having a function of connecting the plant server 111 and the plant controller 112 in the plant 11.

The center 3 shown in FIG. 46 also includes a center database 31 which holds information accumulated in the plant server 111 of the plant 11, real-time information obtained by the plant controller 112, and service information for the end user 2, and a center server 32 which manages various kinds of service.

The plant server 111 and the plant controller 112 provided in the plant 11 and the center database 31 and the center server 32 provided in the center 3 are respectively connected to the wide-area network 4 along with the end user 2. These system components enable a remote service to be offered. All pieces of information are processed via the center 3.

The operation of the remote service offering system according to Embodiment 11 of the present invention will now be described with reference to the drawings.

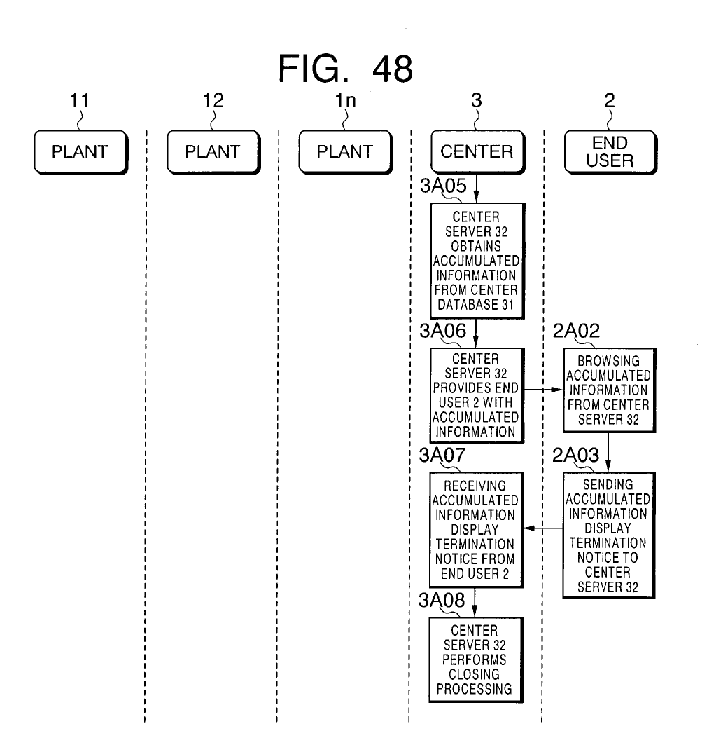

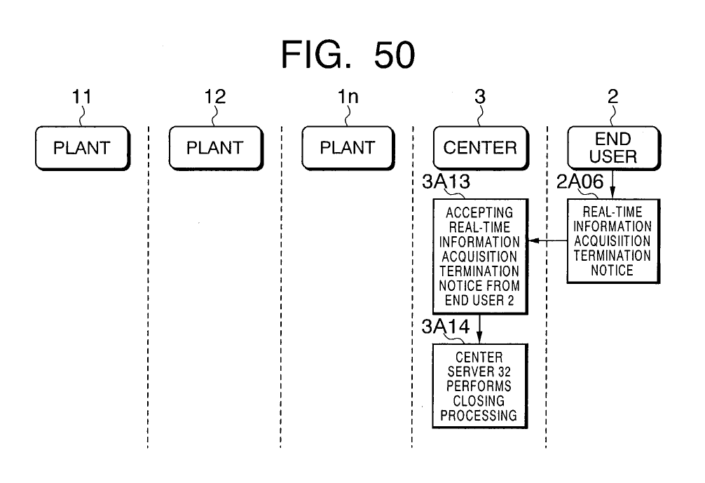

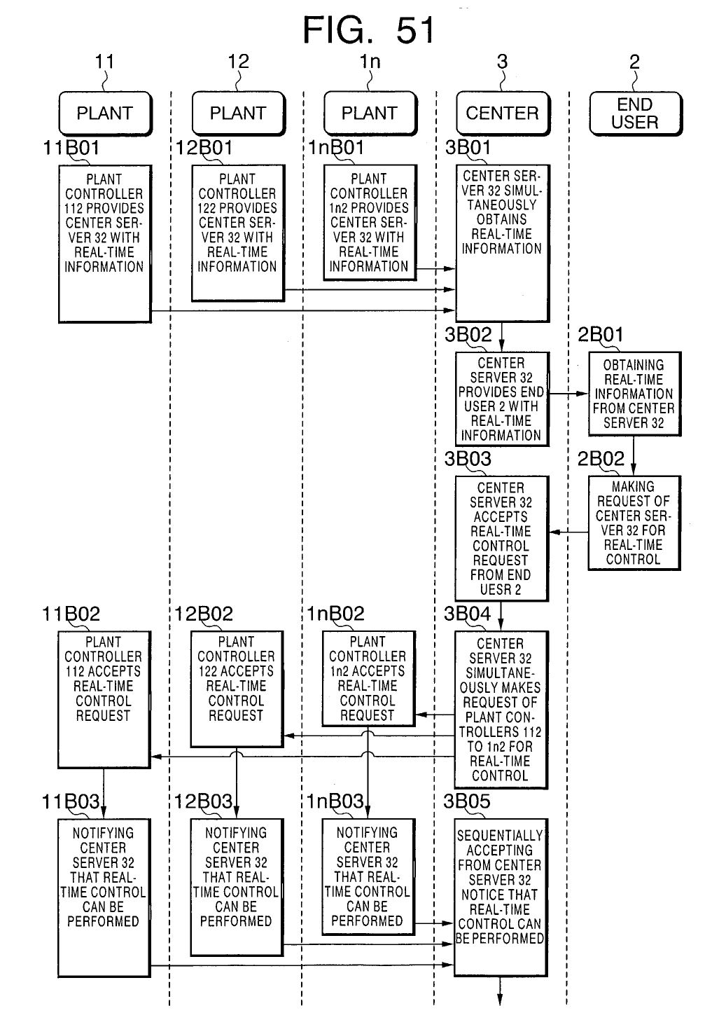

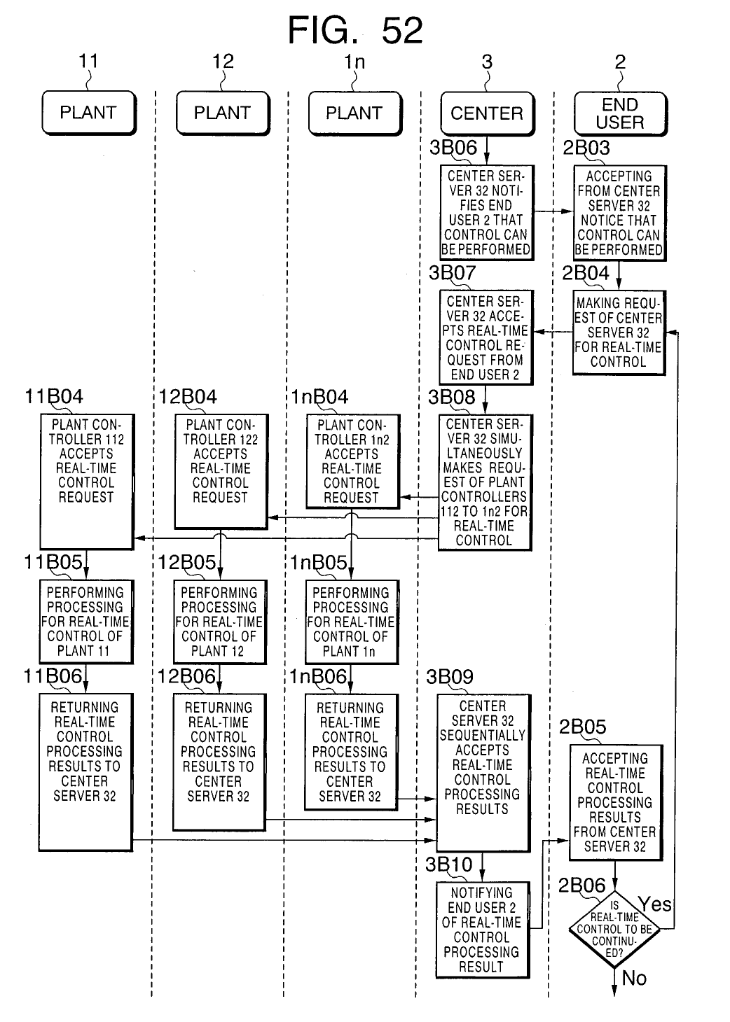

FIGS. 47, 48, 49, and 50 are flowcharts showing the operation of the remote service offering system according to Embodiment 11 of the present invention.

In steps 11A01 to 11A03 shown in FIG. 47, the plant server 111 holds information accumulated in the plant 11. The plant server 111 also updates the accumulated information. Further, the plant server 111 exchanges updated information with the center server 32.

At the same time, in steps 12A01 to 12A03 shown in FIG. 47, the plant server 121 holds information accumulated in the plant 12. The plant server 121 also updates the accumulated information. Further, the plant server 121 exchanges updated information with the center server 32.

Also at the same time, in steps 1nA01 to 1nA03 shown in FIG. 47, the plant server 1n1 holds information accumulated in the plant in. The plant server 1n1 also updates the accumulated information. Further, the plant server 1n1 exchanges updated information with the center server 32.

Next, in steps 3A01 and 3A02, the center server 32 simultaneously obtains accumulated information from the plant servers 111 to 1n1. The center server 32 then stores the accumulated information in the center database 31.

In step 2A01, the end user 2 makes a request of the center server 32 for display (obtainment) of accumulated information.

In steps 3A03 to 3A06, the center server 32 accepts the accumulated information display (obtainment) request from the end user 2 and makes a request of the center database 31 for display (obtainment) of accumulated information. The center server 32 obtains accumulated information from the center database 31 and provides the accumulate information to the end user 2.

Next, in steps 2A02 and 2A03, the end user 2 browses the accumulated information from the center server 32 and sends a notice of termination of display of the accumulated information to the center server 32.

Then, in steps 3A07 and 3A08, the center server 32 accepts the accumulated information display termination notice from the end user 2 and performs closing processing.

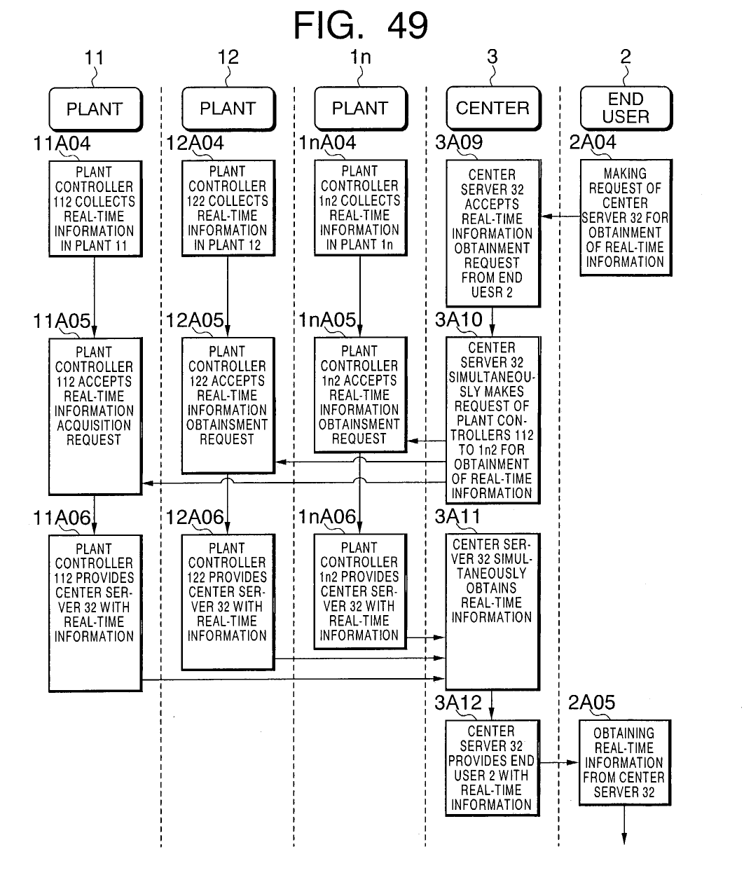

In step 11A04 shown in FIG. 49, the plant controller 112 collects real-time information in the plant 11.

At the same time, in step 12A04, the plant controller 122 collects real-time information in the plant 12.

Also at the same time, in step 1nA04, the plant controller 1n2 collects real-time information in the plant 1n.

In step 2A04, the end user 2 makes a request of the center server 32 for display of real-time information.

In steps 3A09 and 3A10, the center server 32 accepts the real-time information display request from the end user 2 and simultaneously makes a request of the plant controllers 112 to 1n2 for display (obtainment) of real-time information.

Next, in steps 11A05 and 11A06, the plant controller 112 accepts the real-time information display request from the center server 32 and provides real-time information to the center server 32.

At the same time, in steps 12A05 and 12A06, the plant controller 122 accepts the real-time information display request from the center server 32 and provides real-time information to the center server 32.

Also, at the same time, in steps 1nA05 and 1nA06, the plant controller 1n2 accepts the real-time information display request from the center server 32 and provides real-time information to the center server 32.

In steps 3A11 and 3A12, the center server 32 simultaneously obtains the real-time information from the plant controllers 112 to 1n2 and provides the real-time information to the end user 2.

Next, in steps 2A05 and 2A06, the end user 2 displays (obtains) the real-time information from the center server 32 and sends a notice of termination of display (obtainment) of the real-time information to the center server 32.

Then, in steps 3A13 and 3A14, the center server 32 accepts the real-time information acquisition termination notice from the end user 2 and performs closing processing.

Through the above-described procedure, exchange of information via the center server 32 can be controlled in the center 3 at all requests from the end user 2. Also, every piece of information can be handled via the center server 32. Further, every end user 2 can simultaneously handle every piece of information via the center server 32 from the n plants.

Embodiment 12

A remote service offering system according to Embodiment 12 of the present invention will be described with reference to the drawings. A configuration of the remote service offering system according to Embodiment 12 of the present invention is the same as that in Embodiment 11.

In the above Embodiment 2, the real-time control of the plant is performed via the center server 32. However, in Embodiment 12, all the end users 2 simultaneously perform real-time control of plural n plants and confirm the termination of the control.

Next, the operation of the remote service offering system according to Embodiment 12 of the present invention will now be described with reference to the drawings.

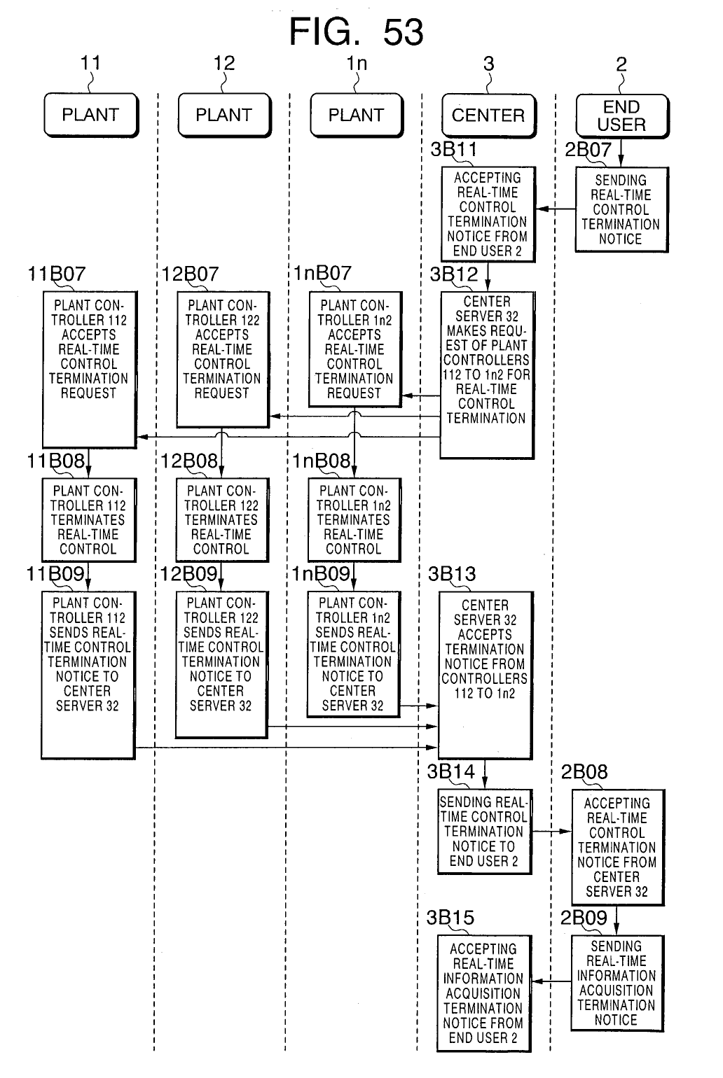

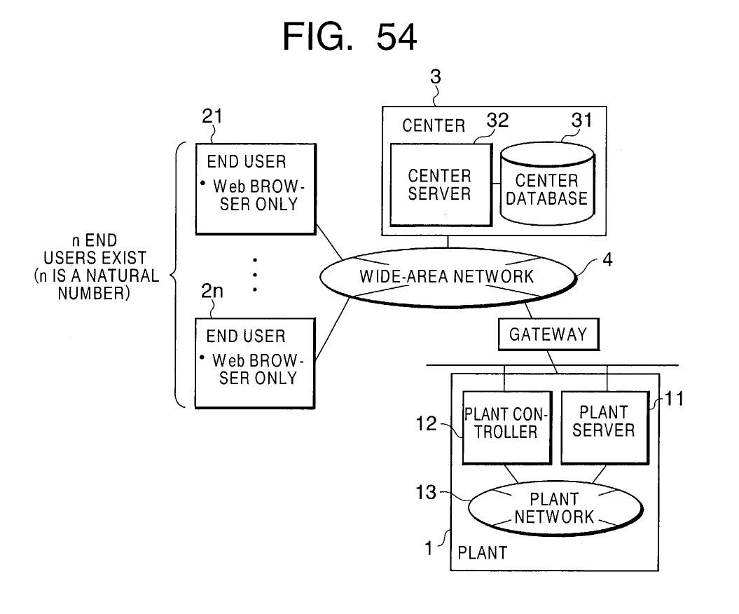

FIGS. 51, 52, and 53 are flowcharts showing the operation of the remote service offering system according to Embodiment 12 of the present invention.

The operation before step 2B01 shown in FIG. 51 is the same as that in Embodiment 11.

Next, in step 2B02, the end user 2 makes a request of the center server 32 for a start of real-time control.

In steps 3B03 and 3B04, the center server 32 accepts the real-time control start request from the end user 2 and simultaneously makes a request of the plant controllers 112 to 1n2 for real-time control.

In steps 11B02 and 11B03, the plant controller 112 accepts the real-time control request from the center server 32 and notifies the center server 32 that real-time control can be performed.

At the same time, in steps 12B02 and 12B03, the plant controller 122 accepts the real-time control request from the center server 32 and notifies the center server 32 that real-time control can be performed.

Also at the same time, in steps 1nB02 and 1nB03, the plant controller 1n2 accepts the real-time control request from the center server 32 and notifies the center server 32 that real-time control can be performed.

In steps 3B05 and 3B06, the center server 32 sequentially accepts from the plant controllers 112 to 1n2 the notice that the real-time control can be performed, and notifies the end user 2 that real-time control can be performed.

In steps 2B03 and 2B04, the end user 2 accepts from the center server 32 the notice that the real-time control can be performed, and makes a request of the center server 32 for real-time control.

Next, in steps 3B07 and 3B08, the center server 32 accepts the real-time control request from the end user 2 and simultaneously makes a request of the plant controllers 112 to 1n2 for real-time control.

In steps 11B04 to 11B06, the plant controller 112 accepts the real-time control request from the center server 32 and performs real-time control processing on the plant 11. The plant controller 112 thereafter notifies the center server 32 of the results of real-time control processing.

At the same time, in steps 12B04 to 12B06, the plant controller 122 accepts the real-time control request from the center server 32 and performs real-time control processing on the plant 12. The plant controller 122 thereafter notifies the center server 32 of the results of real-time control processing.

Also at the same time, in steps 1nB04 to 1nB06, the plant controller 1n2 accepts the real-time control request from the center server 32 and performs real-time control processing on the plant 1n. The plant controller 1n2 thereafter notifies the center server 32 of the results of real-time control processing.

Next, in steps 3B09 and 3B10, the center server 32 accepts the results of real-time control processing sequentially from the plant controllers 112 to 1n2 and notifies the end user 2 of the results of real-time control processing.

In steps 2B05 to 2B07, the end user 2 accepts the results of real-time control processing from the plant controller 2. If real-time control is to be continued, the end user 2 makes the process return to step 2B04. If real-time control is to be stopped, the end user 2 makes a request of the center server 32 for termination of real-time control.

Next, in steps 3B11 and 3B12, the center server 32 accepts the real-time control termination request from the end user 2 and makes a request of the plant controllers 112 to 1n2 for termination of real-time control.

In steps 11B07 to 11B09, the plant controller 112 accepts the real-time control termination request from the center server 32, and terminates the real-time control. The plant controller 112 thereafter notifies the center server 32 of the termination of real-time control.

At the same time, in steps 12B07 to 12B09, the plant controller 122 accepts the real-time control termination request from the center server 32, and terminates the real-time control. The plant controller 122 thereafter notifies the center server 32 of the termination of real-time control.

Also at the same time, in steps 1nB07 to 1nB09, the plant controller 1n2 accepts the real-time control termination request from the center server 32, and terminates the real-time control. The plant controller 1n2 thereafter notifies the center server 32 of the termination of real-time control.

Next, in steps 3B13 and 3B14, the center server 32 accepts the real-time control termination notice sequentially from the plant controllers 112 to 1n2 and notifies the end user 2 of the termination of real-time control.

Then, in steps 2B08 and 2B09, the end user 2 accepts the real-time control termination notice from the center server 32. After this operation, the process returns to the above-described operation of Embodiment 11.

Through the above-described procedure, all kinds of control selected by the end user 2 can be controlled via the center server 32 in the center 3. Also, all kinds of control can be handled via the center server 32. In addition, the real-time control can be terminated. Further, the end user 2 can control the real-time control of plural (n) plants simultaneously and can terminate the real-time control of the plural plants at the same time.

Embodiment 13

A remote service offering system according to Embodiment 13 of the present invention will be described with reference to the drawings. FIG. 54 is a diagram showing a configuration of the remote service offering system according to Embodiment 13 of the present invention.

In the above Embodiment 2, the real-time control of the plant is performed via the center server 32. However, in Embodiment 12, all the end users 2 simultaneously perform real-time control of the plant and confirm the termination of the control.

The remote service offering system shown in FIG. 54 includes a plant 1 in operation, end users 21 to 2n who own the plant 1 and who have a personal computer (PC) having functions corresponding to the functions of a Web browser or the like, a center 3 having a function of intervening in exchange of information between the plant 1 and the end user 2, and a wide-area network 4 in which the plant 1, the end users 21 to 2n and the center 3 are connected. Further, n end users (n is a natural number) exist on the wide-area network 4, where n-th end user is 2n.

The plant 1 shown in FIG. 54 also includes a plant server 11 having a function of storing accumulated information, a plant controller 12 having a function of holding real-time information, and a plant network 13 having a function of connecting the plant server 11 and the plant controller 12 in the plant 1.

The center 3 shown in FIG. 54 also includes a center database 31 which holds information accumulated in the plant server 11 of the plant 1, real-time information obtained by the plant controller 12, and service information for the end user 2, and a center server 32 which manages various kinds of service.

The plant server 11 and the plant controller 12 provided in the plant 1 and the center database 31 and the center server 32 provided in the center 3 are respectively connected to the wide-area network 4 along with the end users 21 to 2n. These system components enable a remote service to be offered. All pieces of information are processed via the center 3.

The operation of the remote service offering system according to Embodiment 13 of the present invention will now be described with reference to the drawings.

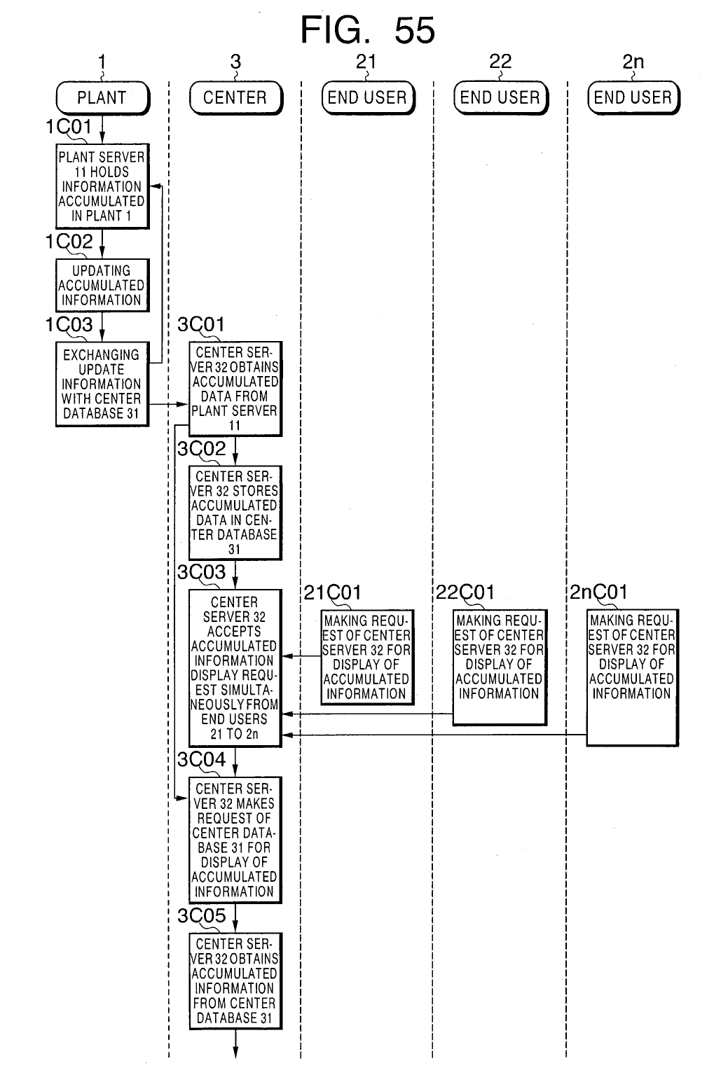

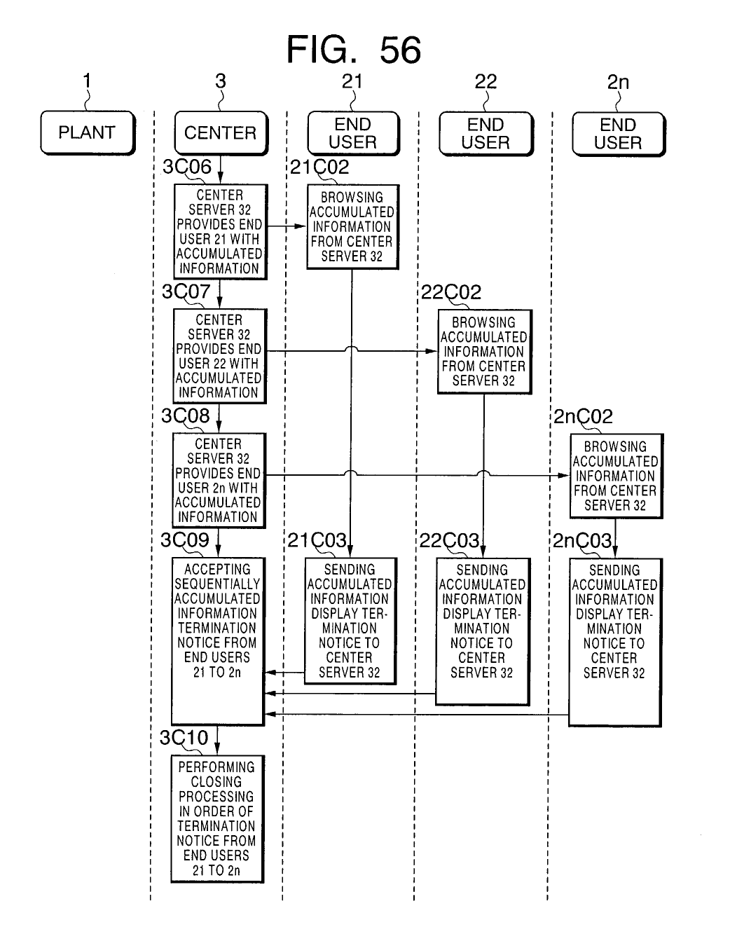

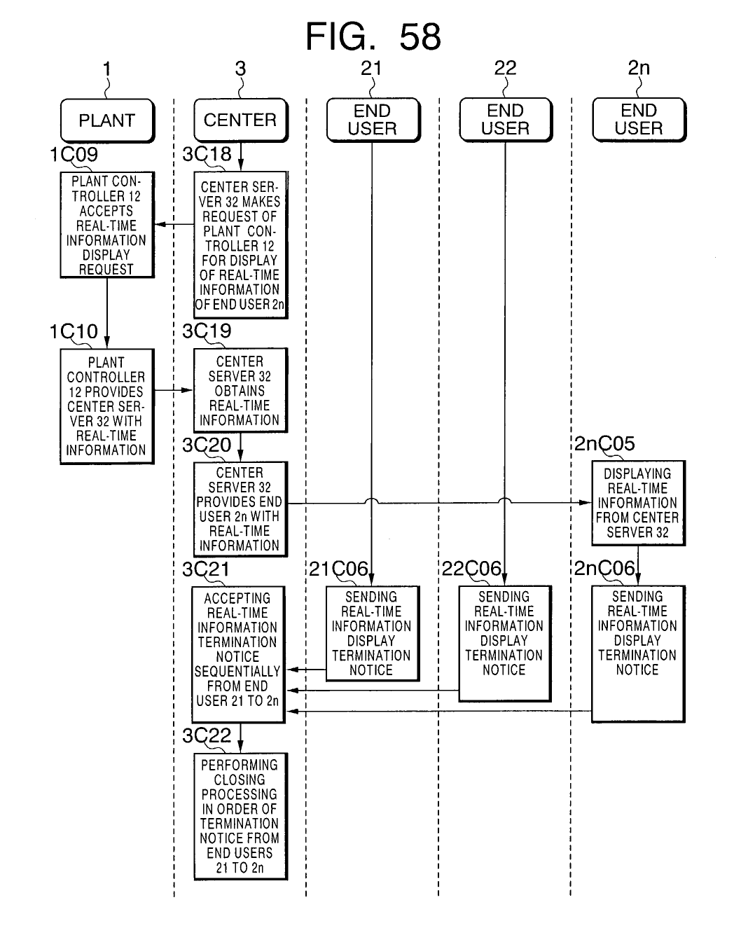

FIGS. 55, 56, 57, and 58 are flowcharts showing the operation of the remote service offering system according to Embodiment 13 of the present invention.

In steps 1C01 to 1C03 shown in FIG. 55, the plant server 11 holds information accumulated in the plant 1. The plant server 11 also updates the accumulated information. Further, the plant server 11 exchanges updated information with the center server 32.

Next, in steps 3C01 and 3C02, the center server 32 obtains accumulated information from the plant server 11. The center server 32 then stores the accumulated information in the center database 31.

In step 21C01, the end user 21 makes a request of the center server 32 for display of accumulated information.

At the same time, in step 22C01, the end user 22 makes a request of the center server 32 for display of accumulated information.

Also at the same time, in step 2C01, the end user 2n makes a request of the center server 32 for display of accumulated information.

In steps 3C03 to 3C08, the center server 32 simultaneously accepts the accumulated information display request from the end users 21 to 2n and makes a request of the center database 31 for display of accumulated information. The center server 32 obtains accumulated information from the center database 31 and provides the accumulated information sequentially to the end users 21 to 2n.

Next, in steps 21C02 and 21C03, the end user 21 browses the accumulated information from the center server 32 and sends a notice of termination of display of the accumulated information to the center server 32.

In steps 22C02 and 22C03, the end user 22 browses the accumulated information from the center server 32 and sends a notice of termination of display of the accumulated information to the center server 32.

In steps 2nC02 and 2nC03, the end user 2n browses the accumulated information from the center server 32 and sends a notice of termination of display of the accumulated information to the center server 32.

Then, in steps 3C09 and 3C10, the center server 32 accepts the accumulated information display termination notice sequentially from the end users 21 to 2n and performs closing processing in order of termination notice.

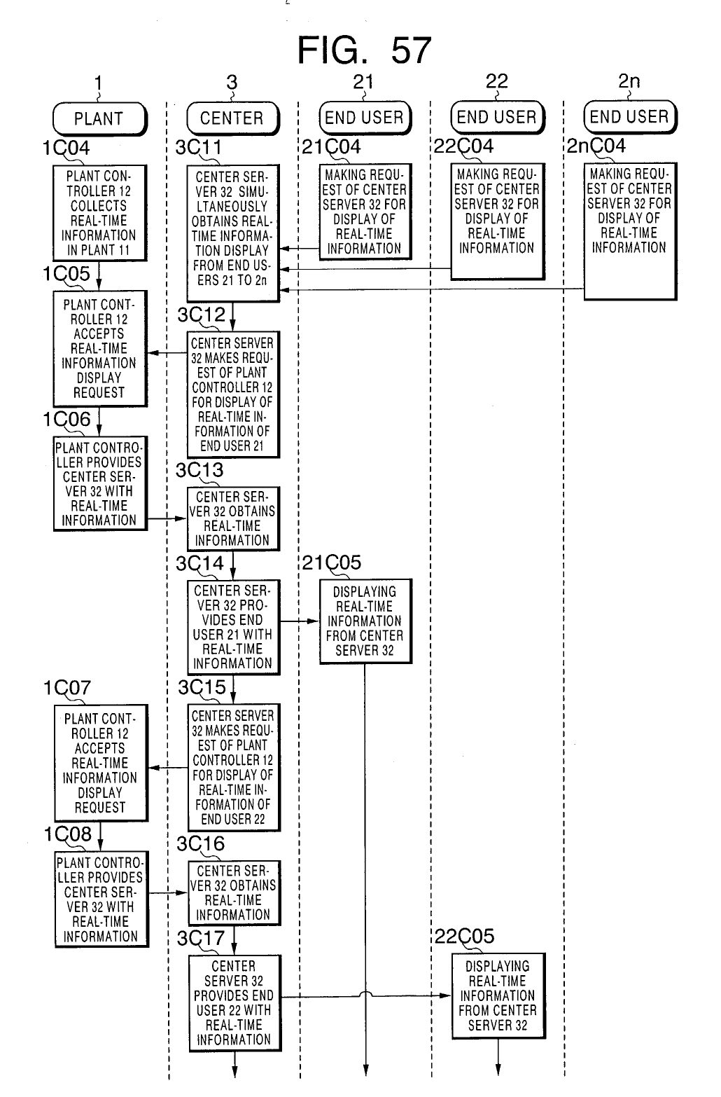

In step 1C04 shown in FIG. 57, the plant controller 12 collects real-time information in the plant 1.

Next, in step 21C04, the end user 21 makes a request of the center server 32 for display of real-time information.

At the same time, in step 22C04, the end user 22 makes a request of the center server 32 for display of real-time information.

Further, in step 2nC04, the end user 2n makes a request of the center server 32 for display of real-time information.

In steps 3C11 and 3C12, the center server 32 accepts the real-time information display request simultaneously from the end users 21 to 2n and makes a request of the plant controller 12 for display of real-time information of the end user 21.

Next, in steps 1C05 and 1C06, the plant controller 12 accepts the real-time information display request from the center server 32 and provides real-time information to the center server 32.

In steps 3C13 and 3C15, the center server 32 obtains the real-time information from the plant controller 12, provides the real-time information to the end user 21, and makes a request of the plant controller 12 for display of real-time information of the end user 22.

In step 21C05, the end user 21 displays the real-time information from the center server 32.

In steps 1C07 and 1C08, the plant controller 12 accepts the real-time information display request from the center server 32 and provides real-time information to the center server 32.

In steps 3C16 to 3C18, the center server 32 obtains the real-time information from the plant controller 12, provides the real-time information to the end user 22, and makes a request of the plant controller 12 for display of real-time information of the end user 2n.

Next, in step 22C05, the end user 22 displays the real-time information from the center server 32.

In steps 1C09 and 1C10, the plant controller 12 accepts the real-time information display request from the center server 32 and provides real-time information to the center server 32.

In steps 3C19 and 3C20, the center server 32 obtains the real-time information from the plant controller 12 and provides the real-time information to the end user 2n.

In step 2nC05, the end user 2n displays the real-time information from the center server 32.

In step 21C06, the end user 21 notifies the center server 32 of the termination of display of real-time information.

In step 22C06, the end user 22 notifies the center server 32 of the termination of display of real-time information.

In step 2nC06, the end user 2n notifies the center server 32 of the termination of display of real-time information.

In steps 3C21 and 3C22, the center server 32 accepts the real-time information display termination notice sequentially from the end users 21 to 2n and performs closing processing in order of termination notice.

Through the above-described procedure, in the center 3, exchange of information via the center server 32 can be controlled at requests from all the end users 21 to 2n. In addition, all pieces of information can be handled via the center server 32. Further, requests for exchange between accumulated information and real-time information of the plant from the plural end users 21 to 2n are processed by the center server 32 sequentially, thereby making it possible to handle all pieces of information via the center server 32 with respect to the plural end users 21 to 2n.

Embodiment 14

A remote service offering system according to Embodiment 14 of the present invention will be described with reference to the drawings. Note that, a configuration of the remote service offering system according to Embodiment 14 of the present invention is the same as that of Embodiment 13 above.

Further, in the above Embodiment 13, requests for exchange of real-time information of the plant 1 from the plural end users 21 to 2n are processed by the center server 32 sequentially, thereby making it possible to handle all pieces of information via the center server 32 with respect to the plural end users 21 to 2n. However, in Embodiment 14, requests for exchange of real-time information from the plural end users 21 to 2n are not processed by the center server 32 sequentially. They are processed by the plant controller 12 sequentially, thereby making it possible to quickly provide the real time information to the plural end users 21 to 2n.

Next, the operation of the remote service offering system according to Embodiment 14 of the present invention will now be described with reference to the drawings.

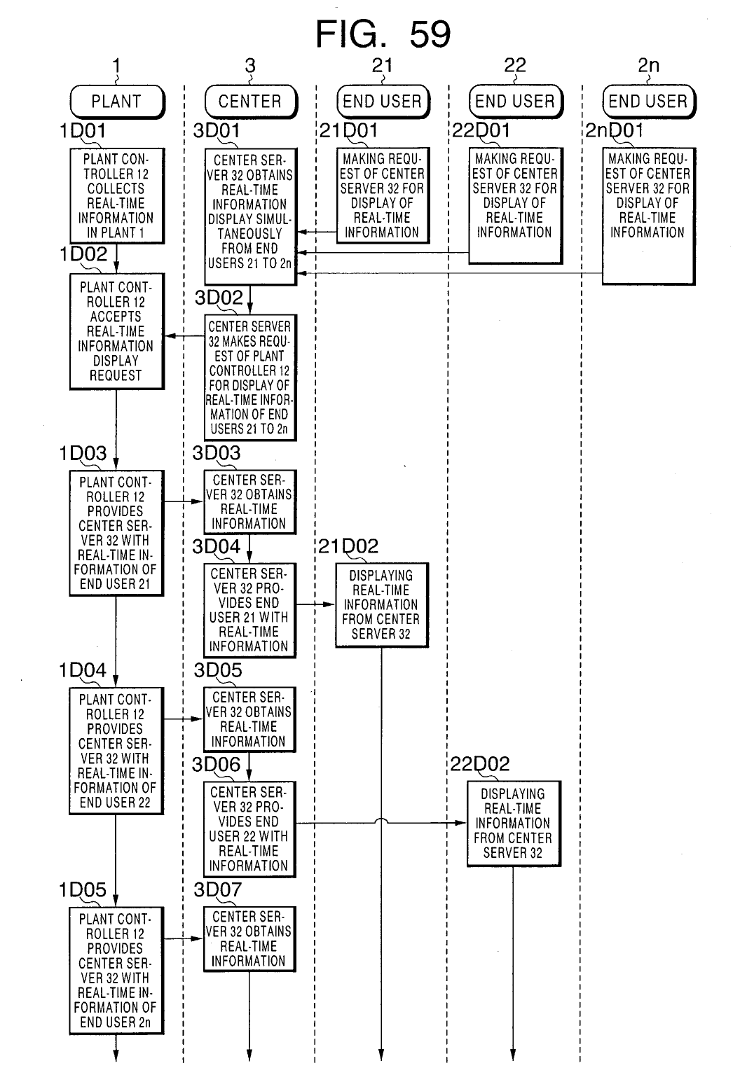

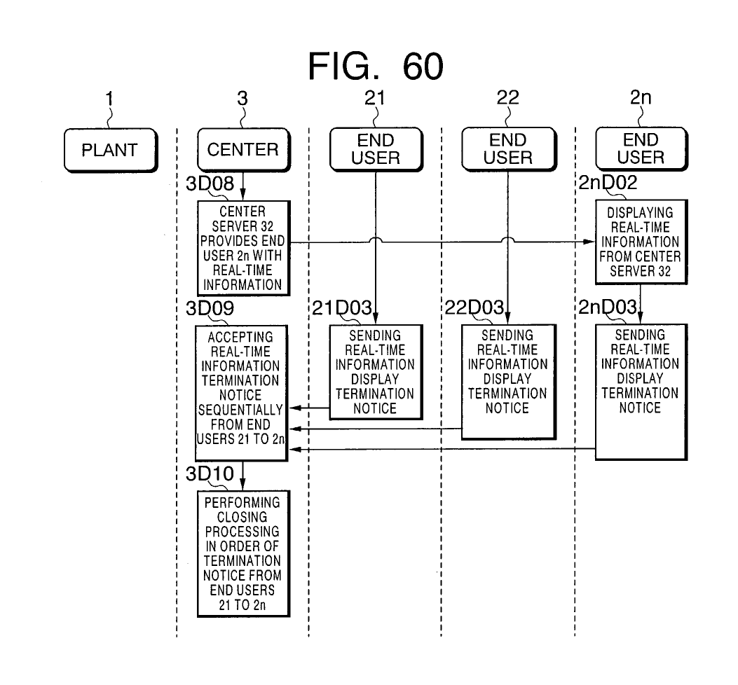

FIGS. 59 to 60 are flowcharts showing the operation of the remote service offering system according to Embodiment 14 of the present invention.

In step 1D01 shown in FIG. 59, the plant controller 12 collects real-time information in the plant 1.

In step 21D01, the end user 21 makes a request of the center server 32 for display of real-time information.

At the same time, in step 22D01, the end user 22 makes a request of the center server 32 for display of real-time information.

Further, in step 2nD01, the end user 2n makes a request of the center server 32 for display of real-time information.

Next, in steps 3D01 and 3D02, the center server 32 accepts the real-time information display request simultaneously from the end users 21 to 2n and makes a request of the plant controller 12 for display of real-time information of the end user 21.

In steps 1D02 and 1D03, the plant controller 12 accepts the real-time information display request from the center server 32 and provides real-time information of the end user 21 to the center server 32.

Next, in steps 3D03 and 3D04, the center server 32 obtains the real-time information from the plant controller 12 and provides the real-time information to the end user 21.

In step 21D02, the end user 21 displays the real-time information from the center server 32.

In step 1D04, the plant controller 12 provides the real-time information of the end user 22 to the center server 32.

In steps 3D05 to 3D06, the center server 32 obtains the real-time information from the plant controller 12 and provides the real-time information to the end user 22.

Next, in step 22D02, the end user 22 displays the real-time information from the center server 32.

In step 1D05, the plant controller 12 provides the real-time information of the end user 2n to the center server 32.

In steps 3D07 and 3D08, the center server 32 obtains the real-time information from the plant controller 12 and provides the real-time information to the end user 2n.

In step 2nD02, the end user 2n displays the real-time information from the center server 32.

In step 21D03, the end user 21 notifies the center server 32 of the termination of display of real-time information.

In step 22D03, the end user 22 notifies the center server 32 of the termination of display of real-time information.

In step 2nD02, the end user 2n notifies the center server 32 of the termination of display of real-time information.

Then, in steps 3D09 and 3D10, the center server 32 accepts the real-time information display termination notice sequentially from the end users 21 to 2n and performs closing processing in order of termination notice.

Through the above-described procedure, requests for exchange of real-time information from the plural end users 21 to 2n are not processed by the center server 32 sequentially. They are processed by the plant controller 12 sequentially, thereby making it possible to quickly provide the real time information to the plural end users 21 to 2n.

Embodiment 15

A remote service offering system according to Embodiment 15 of the present invention will be described with reference to the drawings. Note that a configuration of the remote service offering system according to Embodiment 15 of the present invention is the same as that of Embodiment 13 above.

Further, in the above Embodiment 13, requests for exchange of real-time information of the plant 1 from the plural end users 21 to 2n are processed by the center server 32 sequentially, thereby making it possible to handle all pieces of information via the center server 32 with respect to the plural end users 21 to 2n. However, in Embodiment 15, requests for exchange of real-time information from the plural end users 21 to 2n are not processed by the center server 32 sequentially. They are processed by the plant controller 12 simultaneously, thereby making it possible to quickly provide the real time information to the plural end users 21 to 2n.

The operation of the remote service offering system according to Embodiment 15 of the present invention will now be described with reference to the drawings.

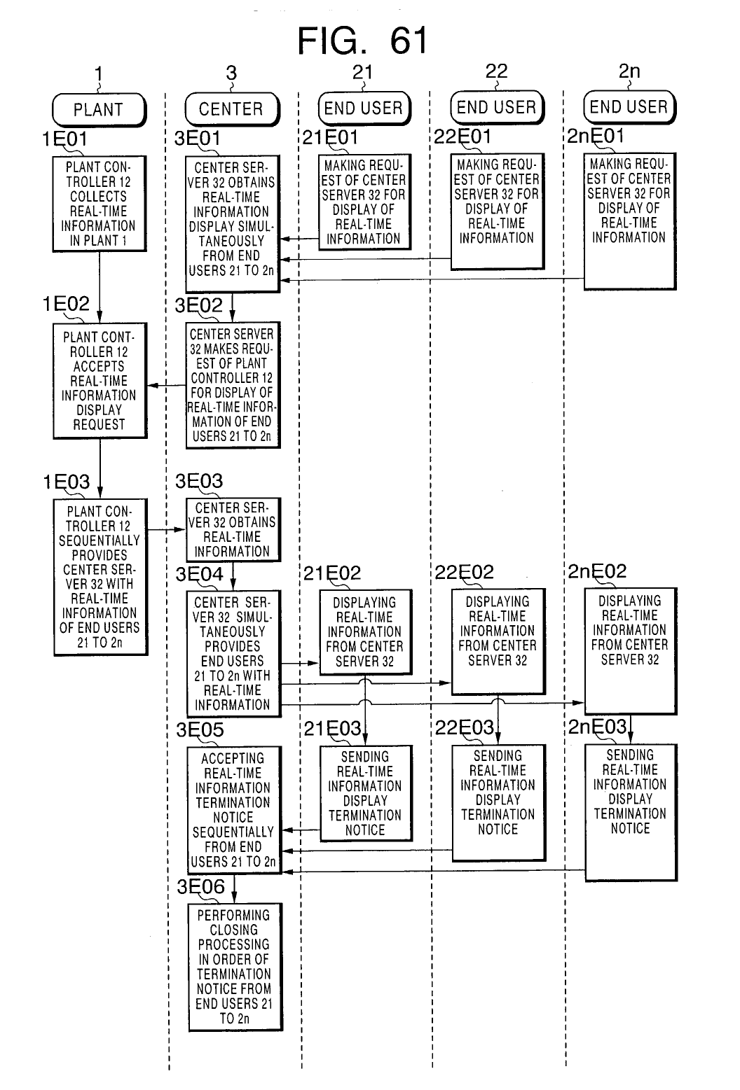

FIG. 61 is a flowchart showing the operation of the remote service offering system according to Embodiment 15 of the present invention.

In step 1E01 shown in FIG. 61, the plant controller 12 collects real-time information in the plant 1.

In step 21E01, the end user 21 makes a request of the center server 32 for display of real-time information.

At the same time, in step 22E01, the end user 22 makes a request of the center server 32 for display of real-time information.

Further, in step 2nE01, the end user 2n makes a request of the center server 32 for display of real-time information.

In steps 3E01 and 3E02, the center server 32 accepts the real-time information display request simultaneously from the end users 21 to 2n and makes a request of the plant controller 12 for display of real-time information of the end users 21 to 2n.

In steps 1E02 and 1E03, the plant controller 12 accepts the real-time information display request from the center server 32 and provides real-time information of the end users 21 to 2n to the center server 32.

In steps 3E03 and 3E04, the center server 32 obtains the real-time information from the plant controller 12 and provides the real-time information simultaneously to the end users 21 to 2n.

In step 21E02, the end user 21 displays the real-time information from the center server 32.

At the same time, in step 22E02, the end user 22 displays the real-time information from the center server 32.

Further, in step 2nE02, the end user 2n displays the real-time information from the center server 32.

Next, in step 21E03, the end user 21 notifies the center server 32 of the termination of display of real-time information.

In step 22E03, the end user 22 notifies the center server 32 of the termination of display of real-time information.

In step 2nE03, the end user 2n notifies the center server 32 of the termination of display of real-time information.

Then, in steps 3E05 and 3E06, the center server 32 accepts the real-time information display termination notice sequentially from the end users 21 to 2n and performs closing processing in order of termination notice.

Through the above-described procedure, requests for exchange of real-time information from the plural end users 21 to 2n are not processed by the center server 32 sequentially. They are processed by the plant controller 12 simultaneously, thereby making it possible to quickly provide the real time information to the plural end users 21 to 2n.

Embodiment 16

A remote service offering system according to Embodiment 16 of the present invention will be described with reference to the drawings. Note that a configuration of the remote service offering system according to Embodiment 16 of the present invention is the same as that of Embodiment 13 above.

In the above Embodiment 2, the real-time control of the plant is performed via the center server 32. However, in Embodiment 16, n end users exist on the wide-area network 4 and the plural end users 21 to 2n simultaneously perform real-time control of the plant 1.

Next, the operation of the remote service offering system according to Embodiment 16 of the present invention will now be described with reference to the drawings.

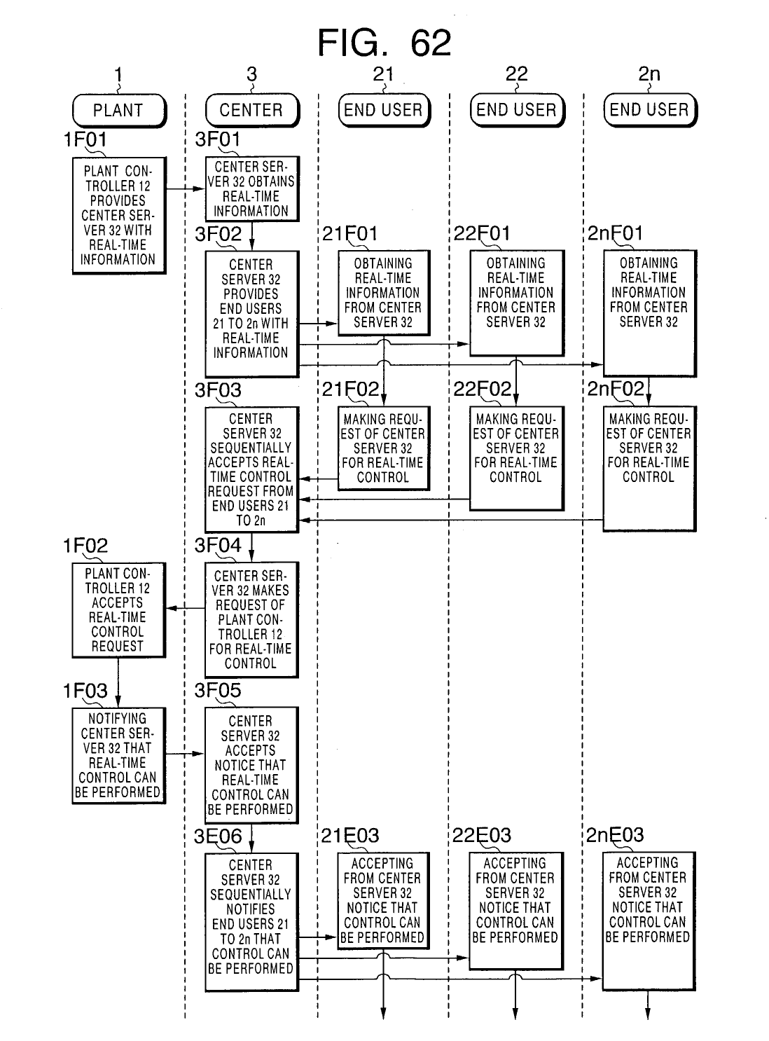

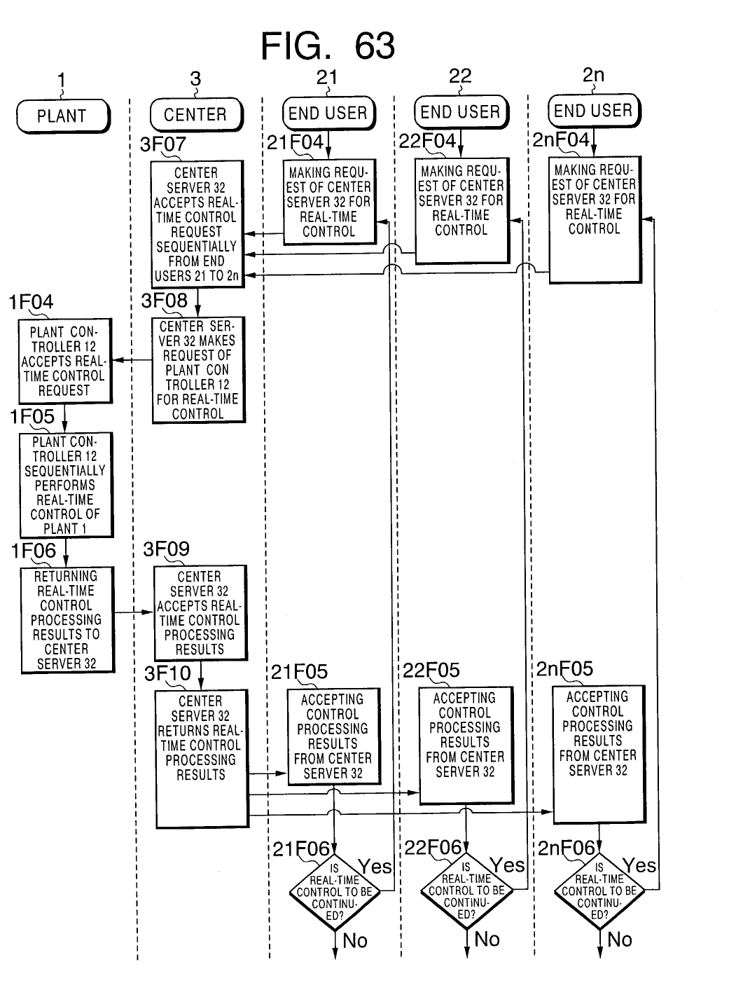

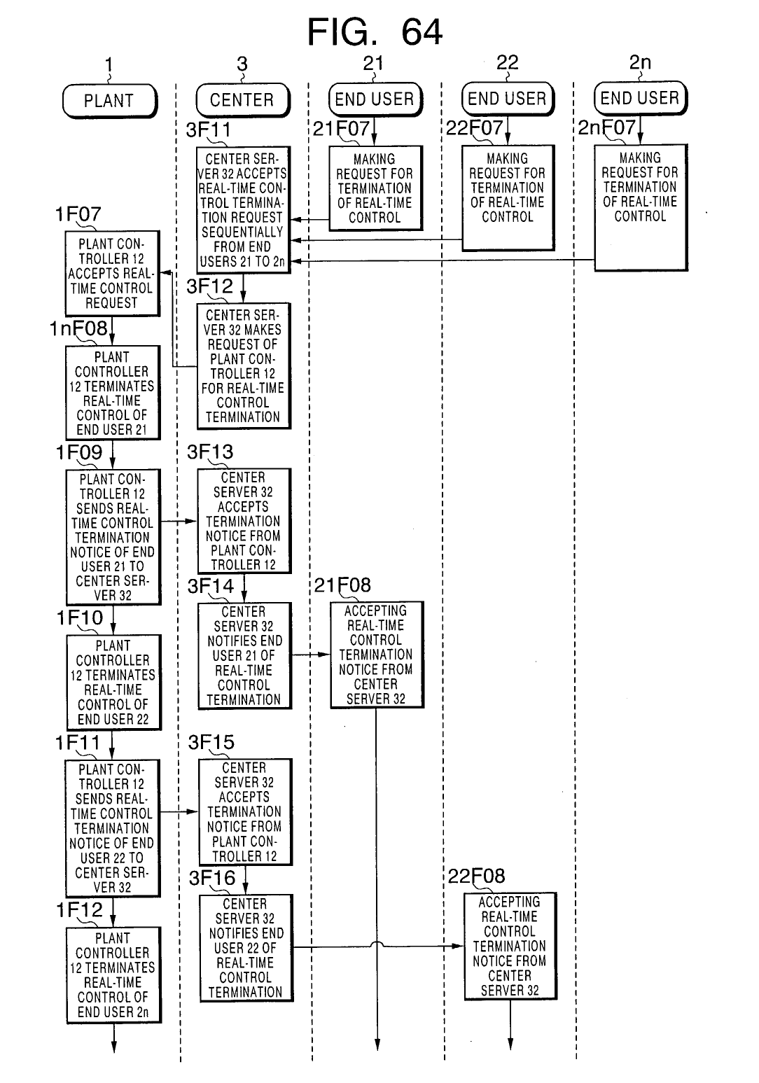

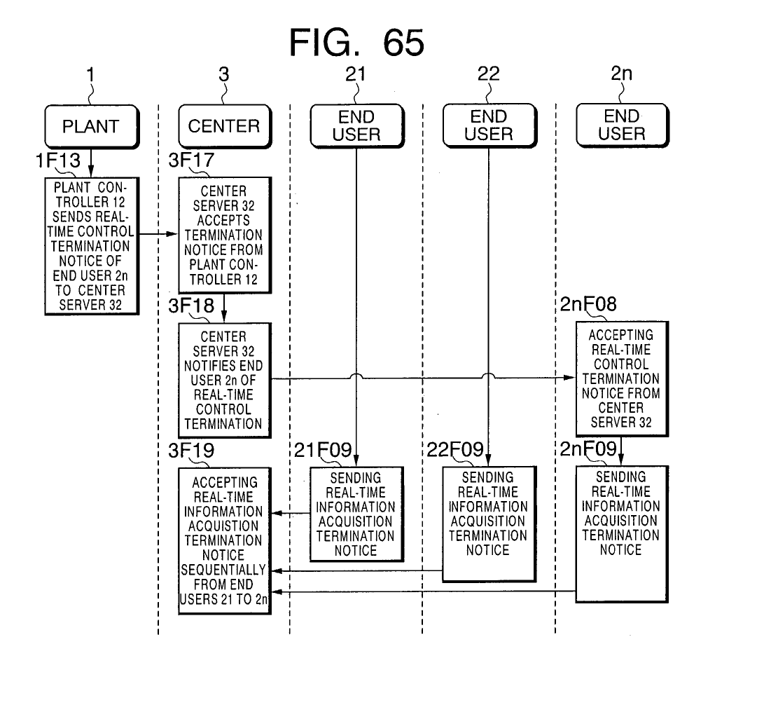

FIGS. 62, 63, 64, and 65 are flowcharts showing the operation of the remote service offering system according to Embodiment 16 of the present invention.

The operation before steps 21F01, 22F01, and 2nF01 shown in FIG. 62 is the same as that in Embodiment 2.

Next, in step 21F02, the end user 21 makes a request of the center server 32 for a start of real-time control.

At the same time, in step 22F02, the end user 22 makes a request of the center server 32 for a start of real-time control.

Further, in step 2nF02, the end user 2n makes a request of the center server 32 for a start of real-time control.

In steps 3F03 and 3F04, the center server 32 accepts the request of a start of real-time control from the end users 21 to 2n and simultaneously makes a request of the plant controller 12 for real-time control.

In steps 1F02 and 1F03, the plant controller 12 accepts the real-time control request from the center server 32 and notifies the center server 32 that real-time control can be performed.

Next, in steps 3F05 and 3F06, the center server 32 accepts from the plant controller 12 the notice that the real-time control can be performed, and sequentially notifies the end users 21 to 2n that real-time control can be performed.

Further, in steps 21F03 and 21F04, the end user 21 accepts from the center server 32 the notice that the real-time control can be performed, and makes a request of the center server 32 for real-time control.

Further, in steps 22F03 and 22F04, the end user 22 accepts from the center server 32 the notice that the real-time control can be performed, and makes a request of the center server 32 for real-time control.

In steps 2nF03 and 2nF04, the end user 2n accepts from the center server 32 the notice that the real-time control can be performed, and makes a request of the center server 32 for real-time control.

In steps 3F07 and 3F08, the center server 32 accepts the real-time control request from the end users 21 to 2n sequentially makes a request of the plant controller 12 for real-time control.

Next, in steps 1F04 to 1F06, the plant controller 12 accepts the real-time control request from the center server 32 and performs real-time control processing on the plant 1. The plant controller 12 thereafter notifies the center server 32 of the results of real-time control processing.

In steps 3F09 and 3F10, the center server 32 accepts the results of real-time control processing from the plant controller 12 and notifies the end users 21 to 2n of the results of real-time control processing.

Further, in steps 21F05 to 21F07, the end user 21 accepts the results of real-time control processing from the plant controller 12. If real-time control is to be continued, the end user 22 makes the process return to step 21F04. If real-time control is to be stopped, the end user 22 makes a request of the center server 32 for termination of real-time control.

In steps 22F05 to 22F07, the end user 22 accepts the results of real-time control processing from the plant controller 12. If real-time control is to be continued, the end user 21 makes the process return to step 22F04. If real-time control is to be stopped, the end user 2n makes a request of the center server 32 for termination of real-time control.

In steps 2nF05 to 2nF07, the end user 2n accepts the results of real-time control processing from the plant controller 12. If real-time control is to be continued, the end user 2n makes the process return to step 2nF04. If real-time control is to be stopped, the end user 2 makes a request of the center server 32 for termination of real-time control.

Next, in steps 3F11 and 3F12, the center server 32 accepts the real-time control termination request sequentially from the end users 21 to 2n and makes a request of the plant controller 12 for termination of real-time control.

In steps 1F07 to 1F09, the plant controller 12 accepts the real-time control termination request from the center server 32, and terminates the real-time control of the end user 21. The plant controller 12 thereafter notifies the center server 32 of the termination of real-time control of the end user 21.

Next, in steps 3F13 and 3F14, the center server 32 accepts the real-time control termination notice of the end user 21 from the plant controller 12 and notifies the end user 21 of the termination of real-time control.

Then, in step 21F08, the end user 21 accepts the real-time control termination notice from the center server 32.

In steps 1F10 and 1F11, the plant controller 12 accepts the real-time control termination request of the end user 22 from the center server 32, and terminates the real-time control thereof. The plant controller 12 thereafter notifies the center server 32 of the termination of real-time control of the end user 22.

In steps 3F15 and 3F16, the center server 32 accepts the real-time control termination notice of the end user 22 from the plant controller 12 and notifies the end user 22 of the termination of real-time control.

Then, in step 22F08, the end user 22 accepts the real-time control termination notice from the center server 32.

In steps 1F12 and 1F13, the plant controller 12 accepts the real-time control termination request of the end user 2n from the center server 32, and terminates the real-time control thereof. The plant controller 12 thereafter notifies the center server 32 of the termination of real-time control of the end user 2n.

Next, in steps 3F17 and 3F18, the center server 32 accepts the real-time control termination notice of the end user 2n from the plant controller 12 and notifies the end user 2n of the termination of real-time control.

Then, in step 2nF08, the end user 2n accepts the real-time control termination notice from the center server 32.

In step 21F09, the end user 21 notifies the center server 32 of the termination of obtainment of real-time information.

In step 22F09, the end user 22 notifies the center server 32 of the termination of obtainment of real-time information.

In step 2nF09, the end user 2n notifies the center server 32 of the termination of obtainment of real-time information.

Next, in step 3F19, the center server 32 accepts a real-time information acquisition termination notice from the end users 21 to 2n sequentially. After this operation, the process returns to the operation of one of the above-described Embodiments 13, 14 and 15.

Through the above-described procedure, in the center 3, exchange of control from the plural end users 21 to 2n can be controlled via the center server 32 with respect to the controls. In addition, all kinds of control can be handled via the center server 32. Further, the real-time control can be terminated. Furthermore, the plural end users 21 to 2n can control the real-time control of the plant 1 sequentially.

What is claimed is:

1. A remote service offering system comprising a plant having a plant server and a plant controller, an end user terminal, and a center having a center database and a center server, said plant, said end user terminal and said center being connected to one another through a wide-area network,
wherein when said center server receives a request for display of accumulated information from said end user terminal, said center server obtains accumulated information held by said plant server and provides the obtained information to said end user terminal, and
wherein when said center server receives a request for display of real-time information from said end user terminal, said center server obtains real-time information collected by said plant controller and provides the obtained information to said end user terminal.

2. A remote service offering system according to claim 1,
wherein when said center server receives a request for a start of real-time control from said end user terminal, said center server transmits the request for a start of real-time control to said plant controller, and, when receiving a request for termination of real-time control from said end user terminal, said center server transmits the request for termination of real-time control to said plant controller, and
wherein said plant controller starts real-time control of said plant when receiving the request for a start of real-time control from said center server, and terminates real-time control of said plant when receiving the request for termination of real-time control from said center server.

3. A remote service offering system according to claim 1, wherein when said center server receives a notice of termination of information display from said end user terminal, said center server sends a notice for confirmation of the termination to said end user terminal, and, when receiving a consent to the confirmation of the termination from said end user terminal, said center server executes closing processing.

4. A remote service offering system according to claim 2, wherein when said center server receives a request for termination of real-time control from said end user terminal, said center server sends a notice for confirmation of the termination to said end user terminal, and, when receiving a consent to the confirmation of the termination from said end user terminal, said center server transmits the request for the termination of real-time control to said plant controller.

5. A remote service offering system comprising an end user terminal and a center having a center database and a center server, said end user terminal and said center being connected to each other through a wide-area network,
wherein when said center server receives a request for acquisition of predetermined information from said end user terminal, said center server checks user information corresponding to said end user terminal in said center database, and provides the predetermined information to said end user terminal based on the user information if the user information exists in the center database and rejects the request for acquisition of the predetermined information if the user information does not exist in the center database.

6. A remote service offering system comprising a plant having a plant server and a plant controller, an end user terminal, and a center having a center database and a center server, said plant, said end user terminal and said center being connected to one another through a wide-area network,
wherein when said center server receives a request for display of accumulated information from said end user terminal, said center server obtains accumulated information held by said plant server, stores the obtained information in said center database, and provides the obtained information to said end user terminal, and
wherein when said plant controller receives a request for display of real-time information from said end user terminal, said center server provides the corresponding collected real-time information to said end user terminal, and when receiving a notice of termination of display of real-time information from said end user terminal via said center server, said plant controller terminates the provision of real-time information to said end user terminal.

7. A remote service offering system comprising a plant having a plant server and a plant controller, an end user terminal, and a center having a center database and a center server, said plant, said end user terminal and said center being connected to one another through a wide-area network,
wherein when said center server receives a request for display of accumulated information from said end user terminal, said center server obtains accumulated information held by said plant server, stores the obtained information in said center database, and provides the obtained information to said end user terminal, and
wherein when said plant controller receives a request for display of real-time information from said end user terminal, said center server provides the corresponding collected real-time information to said end user terminal, and when directly receiving a notice of termination of display of real-time information from said end user terminal, said plant controller terminates the provision of real-time information to said end user terminal.

8. A remote service offering system according to claim 1,
wherein when said center server receives a request for a start of real-time control from said end user terminal, said center server transmits the request for a start of real-time control to said plant controller, and
wherein said plant controller starts real-time control of said plant when receiving the request for a start of real-time control from said center server, and terminates real-time control of said plant when directly receiving a request for termination of real-time control from said end user terminal.

9. A remote service offering system according to claim 1,
wherein when said center server receives a request for a start of real-time control from said end user terminal, said center server transmits the request for a start of real-time control to said plant controller, and, when receiving a request for termination of real-time control from said end user terminal, said center server transmits the request for termination of real-time control to said plant controller,
wherein said plant controller starts real-time control of said plant when receiving the request for a start of real-time control from said center server, terminates real-time control of said plant when receiving the request for termination of real-time control from said center server, and performs real-time control of said plant when directly receiving the request for real-time control from said end user terminal.

10. A remote service offering system according to claim 1, wherein said center server collects a charge determined according to at least one independent variable which is a charging parameter selected from the distance, the connection time, the kind of information, the amount of information, and the kind of user.

11. A remote service offering system according to claim 1,
wherein when a plurality of the plants exist and the center server receives a request for display of accumulated information to be performed simultaneously from the end user terminal to a plurality of the plants, the center server simultaneously obtains accumulated information held by a plurality of the plant servers, stores the accumulated information in the center data base, and provides the accumulated information to the end user terminal, and,
when the center server receives a request for display of real-time information from the end user terminal, the center server obtains plural pieces of real-time information collected by a plurality of the plant controllers and provides the plural pieces of real-time information simultaneously to the end user terminal.

12. A remote service offering system according to claim 1,
wherein when a plurality of the plants exist and the center server receives a request for start of real-time control from the end user terminal, the center server simultaneously transmits the request for start of real-time control to a plurality of the plant controllers and, when receiving a request for termination of real-time control from the end user terminal, the center server simultaneously transmits the request for termination of real-time control to a plurality of the plant controllers,
wherein a plurality of the plant controllers simultaneously start real-time control of a plurality of the plants when receiving the request for start of real-time control from the center server, and simultaneously terminate real-time control of a plurality of the plants when receiving the request for termination of real-time control from the center server.

13. A remote service offering system according to claim 1,
wherein when a plurality of the end user terminals exist and the center server receives a request for display of accumulated information to the plant from a plurality of the end user terminals, the center server obtains accumulated information held by the plant server, stores the accumulated information in the center data base, and provides the accumulated information sequentially to a plurality of the end user terminals, and
when the center server receives a request for display of real-time information from a plurality of the end user terminals, the center server obtains real-time information collected by the plant controller and provides the real-time information sequentially to a plurality of the end user terminals.

14. A remote service offering system according to claim 1, wherein when a plurality of the end users exist and the center server receives a request for display of real-time information from a plurality of the end user terminals, the center server obtains sequentially real time information that is collected by the plant controller to be provided and provides the real-time information to a plurality of the end user terminals.

15. A remote service offering system according to claim 1, wherein when a plurality of the end users exist and the center server receives a request for display of real-time information from a plurality of the end user terminals, the center server obtains the real-time information that is collected by the plant controller to be simultaneously provided and simultaneously provides the real-time information to a plurality of the end user terminals.

16. A remote service offering system according to claim 1,
wherein when a plurality of the end users exist and the center server receives a request for start of real-time control from a plurality of the end user terminals, the center server transmits the request for start of real-time control to the plant controller, and when receiving a request for termination of real-time control from a plurality of the end user terminals, the center server transmits the request for termination of real-time control to the plant controller,
wherein the plant controller simultaneously starts real-time control of the plant when receiving the request for start of real-time control from the center server, and terminates real-time control of the plant sequentially when receiving the request for termination of real-time control from the center server.
